(19) United States
(12) Patent Application Publication
(10) Pub. No.: US 2009/0326995 A1
(43) Pub. Date: Dec. 31, 2009

(54) APPARATUSES, METHODS AND SYSTEMS FOR A TRADE BUSINESS CARD

(76) Inventors: Joseph A. Sorisi, Old Brookville, NY (US); Armand Rousso, New York, NY (US)

Correspondence Address: CHADBOURNE & PARKE LLP, 30 ROCKEFELLER PLAZA, NEW YORK, NY, 10112, US

(21) Appl. No.: 12/108,403

(22) Filed: Apr. 23, 2008

Related U.S. Application Data
(60) Provisional application No. 60/913,521, filed on Apr. 23, 2007.

(51) Int. Cl. G06Q 30/00; G06Q 10/00; G06F 17/30; G06F 15/16; G06F 17/00

(52) U.S. Cl. 705/7; 705/26; 707/104.1; 707/3; 707/E17.044; 707/E17.014; 709/206; 715/226; 715/205

(57) ABSTRACT

This disclosure details apparatuses, methods and systems for a Trade Business Card. The Trade Business Card and Trade Business Card Platform allows users to enter some key business profile data about their company (e.g., address, category of business, customs, DHL, D&B information, telephone number, etc.). This information may then provide other companies and individuals who receive the Trade Business Card access to and the ability to view a provider's services, products and other offerings and to generate a good faith estimate. In one embodiment, the Trade Business Card travels (i.e., is visible) on every Trade Business Card Platform web page and is automatically populated with required data entry fields from searches through the approved purchase process. This eliminates the need for the user or other Trade Business Card Platform participants and/or administrators from having to type in any information about the customer profile manually.

### PRIORITY CLAIMS AND RELATED APPLICATIONS

Applicants hereby claim priority under 35 USC §119 for U.S. provisional patent application Ser. No. 60/913,521 filed Apr. 23, 2007, entitled, “APPARATUSES, METHODS AND SYSTEMS FOR A TRADE BUSINESS CARD,” attorney docket no. 17854.010PV; non-provisional patent application Ser. No. 11/864,900 filed Sep. 28, 2007, entitled, “Apparatuses, Methods and Systems for a Transactional Facilitation Portal,” attorney docket no. 17854-003US1; non-provisional patent application Ser. No. 11/864,902 filed Sep. 28, 2007, entitled, “APPARATUSES, METHODS AND SYSTEMS FOR A TRANSACTIONAL PARAMETER SELECTION INTERFACE,” attorney docket no. 17854-003US2; non-provisional patent application Ser. No. 11/864,903 filed Sep. 28, 2007, entitled, “APPARATUSES, METHODS AND SYSTEMS FOR A PRODUCT MANIPULATION AND MODIFICATION INTERFACE,” attorney docket no. 17854-003US3; non-provisional patent application Ser. No. 11/864,905 filed Sep. 28, 2007, entitled, “Apparatuses, Methods and Systems for a Project and Transactional Parameter Based Search Engine,” attorney docket no. 17854-003US4; non-provisional patent application Ser. No. 11/864,885 filed Sep. 28, 2007, entitled, “SYSTEMS, METHODS AND APPARATUSES FOR IMPORTATION AND EXPORTATION TRANSACTION LOGISTICS FACILITATION,” attorney docket no. 17854-004US1; non-provisional patent application Ser. No. 11/864,888 filed Sep. 28, 2007, entitled, “SYSTEMS, METHODS AND APPARATUSES FOR A PAYMENT FACILITATION ENGINE,” attorney docket no. 17854-005US1; non-provisional patent application Ser. No. 11/864,895 filed Sep. 28, 2007, entitled, “SYSTEMS, METHODS AND APPARATUSES FOR IMPORTATION AND EXPORTATION TRANSACTION FACILITATION,” attorney docket no. 17854-006US1; and non-provisional patent application Ser. No. 11/864,898 filed Sep. 28, 2007, entitled, “SYSTEMS, METHODS AND APPARATUSES FOR IMPORTATION AND EXPORTATION PROCUREMENT, LOGISTICS, AND PAYMENT TRANSACTION FACILITATION,” attorney docket no. 17854-006US2.

Applicants hereby claim priority for Patent Cooperation Treaty patent application serial no. PCT/US07/80021 filed Sep. 28, 2007, entitled “APPARATUSES, METHODS AND SYSTEMS FOR CROSS BORDER PROCUREMENT,” attorney docket no. 17854.003PC; Patent Cooperation Treaty patent application serial no. PCT/US07/80020 filed Sep. 28, 2007, entitled “SYSTEMS, METHODS AND APPARATUSES FOR IMPORTATION AND EXPORTATION TRANSACTION FACILITATION,” attorney docket no. 17854.004PC; Patent Cooperation Treaty patent application serial no. PCT/US07/80022 filed Sep. 28, 2007, entitled “SYSTEMS, METHODS AND APPARATUSES FOR PAYMENT FACILITATION ENGINE,” attorney docket no. 17854.005PC; and Patent Cooperation Treaty patent application serial no. PCT/US07/80019 filed Sep. 28, 2007, entitled “SYSTEMS, METHODS AND APPARATUSES FOR IMPORTATION AND EXPORTATION TRANSACTION FACILITATION,” attorney docket no. 17854.006PC.

This application is related to U.S. provisional patent application Ser. No. 60/827,687 filed Sep. 29, 2006, entitled, “APPARATUSES, METHODS AND SYSTEMS FOR MARKET GENERATION AND MATCHES OF IMPORTATION AND EXPORTATION TRANSACTIONS,” attorney docket no. 17854.006PV; and United States provisional patent application Ser. No. 60/870,561 filed Dec. 18, 2006, entitled, “APPARATUSES, METHODS AND SYSTEMS FOR MARKET GENERATION AND MATCHES OF IMPORTATION AND EXPORTATION TRANSACTIONS,” attorney docket no. 17854.006PV1.

The entire contents of the aforementioned applications are herein expressly incorporated by reference.

### FIELD

The present disclosure is directed generally to apparatuses, methods, and systems of data exchange, and more particularly, to apparatuses, methods and systems for a trade business card.

### BACKGROUND

The process of exporting and importing merchandise, or cross-border trade, is an old process, and in many ways has changed little over the centuries. Such import and export transactions were often facilitated by human and interpersonal interactions whereby contact information was exchanged in the form of business cards as between individuals.

The traditional entities involved in the trade process generally include: the carrier, the freight agent, the bank, the insurer, the government regulatory agency, the buyer and the seller. Traditionally, the export-import process utilizes hard copy documents for information distribution and storage, as well as, multiple third party service providers that are managed and coordinated by the trading parties themselves (i.e., management and control of the transaction process and regulatory responsibilities are conducted in-house). Additionally, letters of credit are used as methods of payment and collection. The traditional process is document-based, requiring paper documentation to evidence various elements of the transaction, from price quotation, to the transfer of ownership and collection of proceeds. This scenario is still prevalent today among most small to mid-sized firms engaged in trade. As such, import/export has long been a physical and interpersonal activity. Buyers, sellers and agents need to negotiate terms, and then have to navigate formidable cross-border regulations and paperwork to engage in the trade of goods. In various embodiments, cross-border trade may also include exporters, forwarders, carriers, brokers, importers, banks, customs, and other players that are involved in facilitating trade.

Over time, various online Business-to-Business (B2B) trade-related web sites have been launched that include trade boards, barter sites, vertical exchanges and portals. Trade boards offer member buyers and sellers a variety of trade leads. These trade leads most often contain hyper-links to vendor websites, so that any buyer-seller discovery happens separately between the two trading parties. Examples of these types of B2B sites include TradeXpro.com, and Eceurope.com. Barter sites serve specific sellers who need to sell over-stocked or distressed products and often use auction software. Examples of these types of B2B sites include Liquidation.com. Vertical exchanges focus on single industries. Member sellers compete for visiting buyers focused on specific products. For example, the AgriSeek exchange features agricultural commodities, products and services; Industry2Industry.com links buyers of industrial equipment to its member vendors' websites; the European Plant Exchange serves growers, suppliers and traders of plants and seed in Europe; and Elemica.com, formed by 22 founding chemical companies, facilitates the buying and selling of bulk chemicals on its site. B2B portals offer multi-vertical exchanges. Examples of B2B portals include B2Business.net, Bocat.com, Alibaba.com and Worldbid.com.

Online profiles for users engaging and/or using B2B trade-related websites or other types of websites exist. Generally, such profiles are formed on a user-specific basis. Users are generally permitted to enter any information they wish in their profiles and to edit their profile information as they wish. Often, user profile information is for the use of the websites only and not made available to other website users.

### SUMMARY

The disclosure details the implementation of apparatuses, methods, and systems for implementing, managing and/or distributing a trade business card (hereinafter “Trade Business Card”).

Through its various components, the cross-border Trade Business Card facilitates import export transactions and/or other online transactions. The Trade Business Card is part of a customer's initial registration experience with the Transactor described in U.S. provisional patent application Ser. No. 60/827,687 filed Sep. 29, 2006, entitled “APPARATUSES, METHODS AND SYSTEMS FOR MARKET GENERATION AND MATCHES OF IMPORTATION AND EXPORTATION TRANSACTIONS” and in U.S. provisional patent application Ser. No. 60/870,561 filed Dec. 18, 2006, entitled “APPARATUSES, METHODS AND SYSTEMS FOR MARKET GENERATION AND MATCHES OF IMPORTATION AND EXPORTATION TRANSACTIONS” both of which are herein incorporated by reference. The Transactor is also referred to in the instant description as a “Trade Business Card Platform”.

The Trade Business Card Platform entry facility allows users to enter some key business profile data about their company (e.g., address, category of business, customs, DHL, D&B information, telephone number, etc.). This information may then provide other companies and individuals who receive the Trade Business Card access to and the ability to view a provider's services, products and other offerings. It will also allow other companies and individuals to generate a good faith estimate.

In one embodiment, the Trade Business Card travels (i.e., is visible) on every Trade Business Card Platform web page and is automatically populated with required data entry fields from searches through the approved purchase process. This eliminates the need for the user [or Trade Business Card Platform administrators (e.g., B2X Operations)] from having to type in any information about the customer profile manually.

As such, the Trade Business Card offers a number of special advantages such as:

An electronic Image of a Business card may be embedded on web pages;

The Trade Business Card designates a company (e.g., not an individual) at the highest level of security responsible for transacting with the Trade Business Card Platform (e.g., B2X, which limits risk);

The Trade Business Card ameliorates administrative difficulties associated with employee turnover because as employees change, the Trade Business Card is tied to the company as opposed to an individual within the company, and as such, ties to authorized buyers/sellers are maintained. This avoids losses over individual approval and minimizes disputes as the company is held responsible;

The Trade Business Card assigns, Approved Buyers and Authorized Signatories to the transaction

Since this is visible through-out the entire online experience, there is no need to have a customer enter any other data other than “ship to” information, if required;

Moreover, the Trade Business Card data is always resident and users can edit at any time, so there is no wiggle room for dispute.

### BRIEF DESCRIPTION OF THE DRAWINGS

The accompanying appendices and/or drawings illustrate various non-limiting, example, inventive aspects in accordance with the present disclosure:

FIGS. 1A-B show aspects of overall logic flow in one embodiment of Trade Business Card Platform operation;

FIG. 2 shows an implementation of data flow among Trade Business Card Platform components and auxiliary and participating entities in one embodiment of Trade Business Card Platform operation;

FIGS. 3A-B show an implementation of logic flow for user registration and Trade Business Card generation in one embodiment of Trade Business Card Platform operation;

FIG. 4 shows an implementation of logic flow for imparting a buyer Trade Business Card record to a seller in one embodiment of Trade Business Card Platform operation;

FIG. 5 shows an implementation of logic flow for imparting a seller Trade Business Card record to a buyer in one embodiment of Trade Business Card Platform operation;

FIG. 6 shows an implementation of logic flow for connecting Trade Business Card-originated messages and/or inquiries to specific recipients in one embodiment of Trade Business Card Platform operation;

FIG. 7 shows an implementation of a registration user interface in one embodiment of Trade Business Card Platform operation;

FIGS. 8A-B show an implementation of a Trade Business Card Platform catalog page and Trade Business Card electronic business card user interface in one embodiment of Trade Business Card Platform operation;

FIGS. 9A-F illustrate further aspects of a Trade Business Card in the context of an online import-export trading facility and/or Trade Business Card Platform website in another embodiment of Trade Business Card Platform operation; and

FIG. 10 is of a block diagram illustrating aspects of a cross-border Trade Business Card controller.

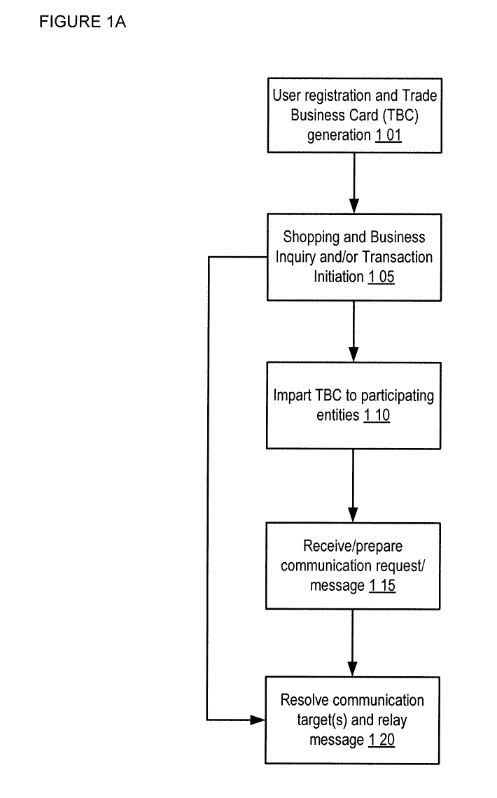

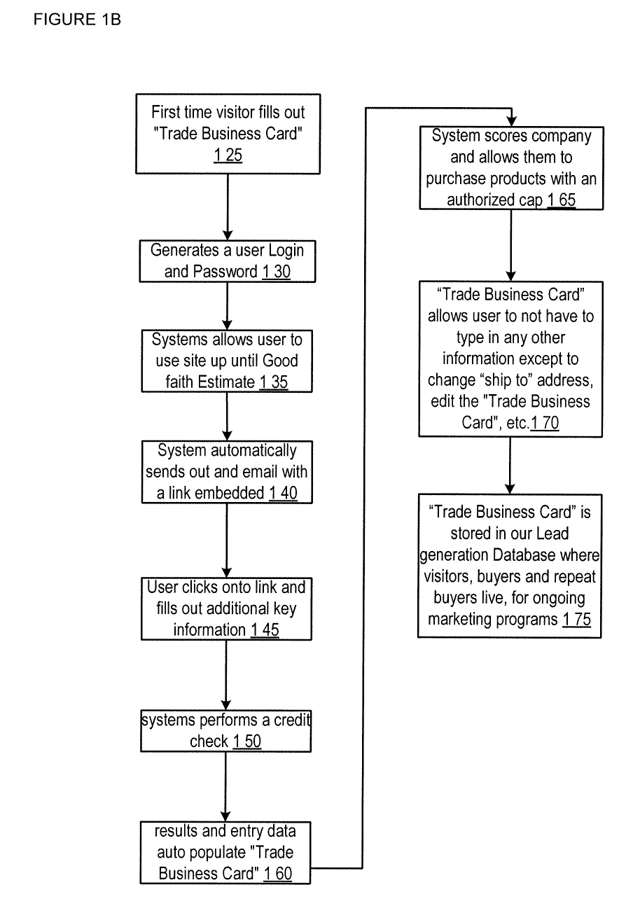

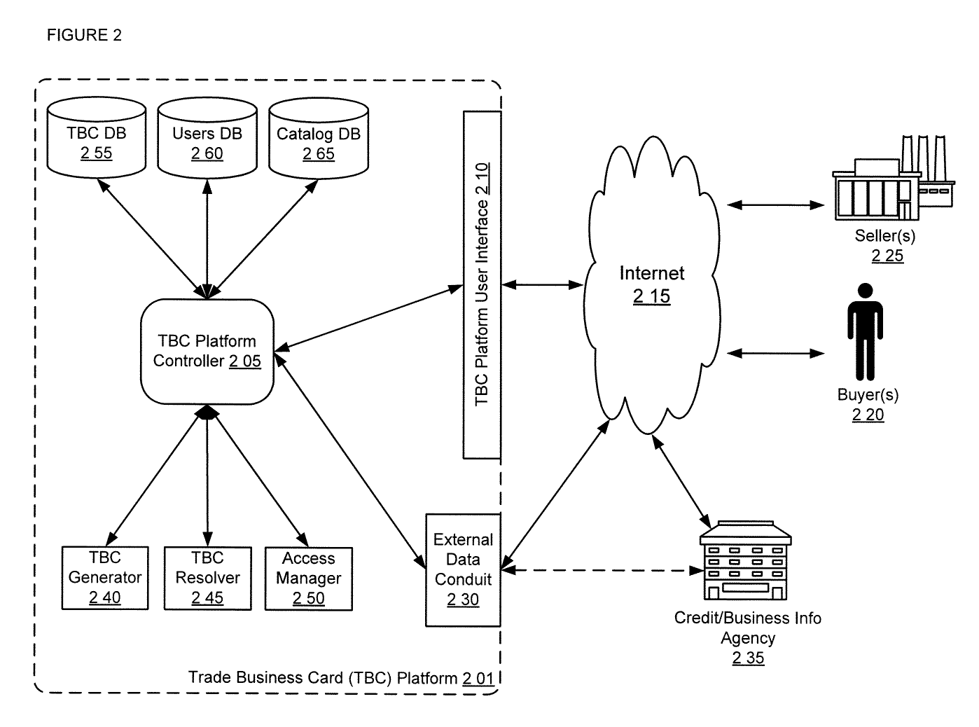

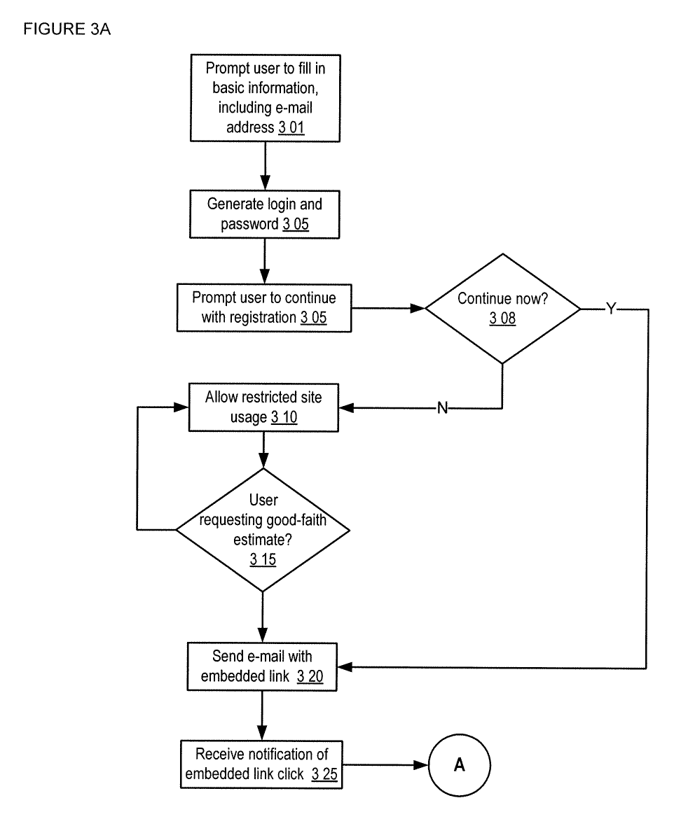

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### Trade Business Card Platform Operation

This disclosure details implementations of apparatuses, methods and systems for a trade business card (hereinafter, “TBC”) and trade business card platform (hereinafter, “TBC Platform”). It is to be understood that, depending on the particular needs and/or characteristics of a TBC Platform administrator, online marketplace, buyer(s), seller(s), third party business information agency, and/or the like, various embodiments of the TBC Platform may be implemented that enable a great deal of flexibility and customization. The instant disclosure details an embodiment of the TBC Platform within the context of an online marketplace directed primarily to market generation, cross-border trade, and matches of importation and exportation transactions. However, it is to be understood that the system described herein may be readily configured and/or customized for a wide range of other applications or implementations. For example, aspects of the TBC Platform may be adapted for use in managing corporate identities in the context of a wide variety of online forums, in a searchable business index, as a form of electronic letterhead, as a compact collection of business information, and/or the like. It is to be understood that aspects of the TBC Platform may be further adapted to other implementations or identity and/or business information management applications.

FIG. 1A shows an implementation of overall logic flow illustrating aspects of one embodiment of TBC Platform operation. At 101, a TBC Platform user may initiate a registration process wherein a variety of business information is provided to effectuate the generation of a new TBC. In one embodiment, the TBC Platform may comprise an online shopping forum, such as may facilitate cross-border import-export transactions, and a TBC Platform user may comprise one or more buyers, sellers, corporate entities, individuals, government organizations, third-party credit and/or business information entities, and/or the like. Creation of a new TBC, as detailed below, may occur at an organization-specific level rather than on a level specific to the particular user creating the account. Thus, for example, a user who is an employee of a particular company may generate a TBC that is keyed to a company identifier (ID) rather than to a user ID. Once a user has successfully generated a new TBC, access may be granted for shopping, browsing, and/or other activities within the TBC Platform and/or any other platform for which access is TBC regulated. It should be understood that such external platforms subject to TBC-based access regulation are encompassed in discussions of the TBC Platform. In the context of TBC Platform activities, the user may submit a business inquiry and/or attempt to initiate a transaction 105. These actions may, in turn, trigger the TBC Platform to impart appropriate TBCs to participating entities 110. For example, in one implementation, if a Buyer user attempts to initiate the purchase of a particular set of items within a TBC Platform catalog that are being sold by a Seller user, the Buyer's TBC may be imparted to the Seller as part of the transaction offer. In another implementation, the Seller's TBC may also be receivable by the Buyer, such as by being included on the TBC Platform catalog page displaying the product in question and/or by being transmitted to the Buyer once an inquiry is received therefrom and/or when a transaction has been initiated. TBC Platform users may use TBCs in communicating with one another. Consequently, the TBC Portal may receive TBC initiated communication requests and/or prepare messages in response to user actions (e.g., a transaction offer notice in response to a user's transaction initiation) 115. In attempting to communicate a message to an entity specified by a TBC, the TBC Portal may resolve a particular communication target associated with the TBC (e.g., the e-mail address of a particular user associated with a company whose TBC has been used to initiate a communication request) and subsequently relay the message thereto.

FIG. 1B shows an alternative implementation of overall logic flow illustrating aspects of another embodiment of TBC Platform operation. A first time visitor fills out a TBC 125 and generates a login and password 130. The systems then allow the user to use the site up to receiving a good faith estimate for a purchase 135. At that time, the system automatically sends an e-mail to the user with an embedded link contained therein 140. The user clicks on the link and fills out additional key registration information 145, based on which the system may perform a credit check 150. The results of the credit check and data entered by the user are used to auto-populate a TBC record 160. The system may also assign a score to the company and allow them to purchase products falling within an authorized cap, such as may be based on the assigned score 165. The TBC, in turn, allows the user to avoid typing in business information, such as when making a purchase, but rather to only input shipping information and refer the system to the TBC for the balance of information requested 170. The TBC may be stored in a TBC database and/or lead generation database 175, where TBC platform participants transact, communicate, and/or otherwise interact with one another.

FIG. 2 shows an implementation of data flow among TBC Platform components and auxiliary and participating entities in one embodiment of TBC Platform operation. The TBC Platform itself 201 may comprise a TBC Platform Controller 205 that may serve a central role in the operation, management, and coordination of TBC Platform components and data exchanges. In alternative embodiments, the TBC Platform Controller may itself contain any or all of the other TBC components shown in the figure. The TBC Platform Controller 205 may be communicatively coupled to a TBC Platform User Interface (UI), configurable to display TBC Platform product catalog pages, TBCs, user registration pages, and/or the like. In one implementation, TBC Platform users such as buyers 220 and sellers 225 may interact with the TBC Platform UI 210 via the internet 215 and/or other communication networks. The TBC Platform Controller 205 may further be coupled to one or more credit and/or business information agencies 235 via the internet 215 and/or a separate, direct external data conduit 230.

The TBC Platform Controller 205 may further be coupled to a plurality of TBC Platform modules configured to engage, process, generate, and/or manage TBC Platform data. A TBC Generator 240 may be configured to produce and/or process user registration forms, parse and/or interpret user registration information, collect registration information in a TBC data structure, configure TBC data structure information for UI display, communicate with and/or process information received from one or more credit and/or business information agencies, and/or the like. A TBC Resolver 245 be configured to extract specific and/or targeted information from a TBC record, resolve particular contact information associated with a TBC record, discern one or more TBCs associated to a particular product and/or TBC Platform catalog entry, and/or the like. An Access Manager 250 may be configured to analyze registration information and/or information received from one or more credit and/or business information agencies to determine, assign, and/or enforce TBC Platform access restrictions with respect to various TBC Platform users and/or participants. In one implementation, the Access Manager may be configured to receive information associated with proposed transactions, compare said transaction information with credit ratings, credit caps, Better Business Bureau ratings, and/or other credit and/or business information associated with one or more transaction participants, and determine whether to allow the transaction, block the transaction, flag the transaction for one or both participants with either an approval or disapproval indicator, and/or the like.

The TBC Platform Controller 205 may further be coupled to one or more databases configured to store data and/or records associated with TBC Platform operation. A TBC database (DB) 255 may contain TBC records, each containing a variety of fields pertaining to the TBC, associated company and/or organization, users, and/or the like. For example, in one implementation, a TBC record may include fields such as, but not limited to: company name, company address, user name, email address, password, phone number, fax number, authorized buyer information, signatory information, Dunn & Bradstreet (D&B) number, Federal Tax ID (FED) and/or Employer Identification Number (EIN), state resale certificate, field/industry, opt-ins to alerts, fields/industries of interest, and/or the like. A Users DB 260 may contain records pertaining to individual users, user accounts, user interaction histories with the TBC Platform, transactions, user relationships and/or statuses, contact information, and/or the like. A Catalog DB 265 may contain records pertaining to TBC Platform catalog entries, products, transactions, prices, and/or the like. Further detail pertaining to the DBs shown in FIG. 2 and records and/or tables contained therein is provided below in the detailed discussion of the TBC Platform Controller.

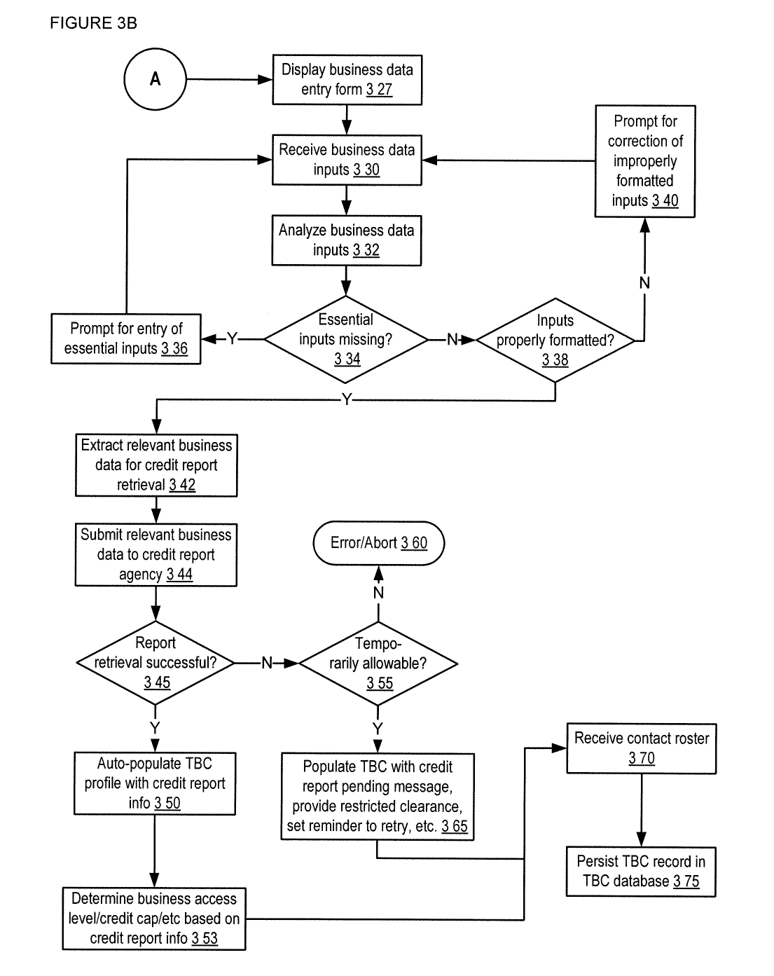

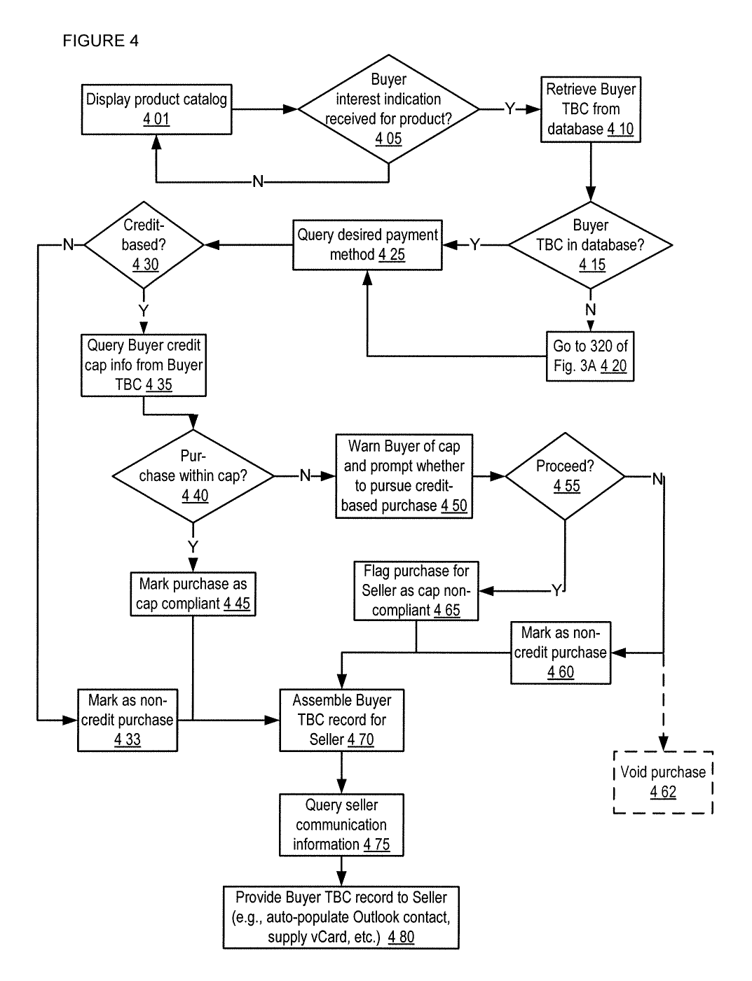

FIGS. 3A-B show an implementation of logic flow for user registration and TBC generation in one embodiment of TBC Platform operation. A new TBC platform user may be prompted to enter basic information that may, at a minimum, include an email address 301. Other basic information that may be prompted for in an initial request may include user name, contact information, company name and address, phone number, fax number, by whom the user was referred, an affiliate number, trademark information and/or images, and/or the like. Once the user's basic information has been entered, the TBC Platform may generate a login and password 305. In an alternative implementation, a user may be permitted to personally select a login and/or password. The TBC platform may then query the user 305 as to whether or not he or she wishes to continue with the full registration process at this time 308. If not, then the user and/or other users affiliated with and/or authorized by the same company as the user may be allowed restricted usage of TBC Platform features, the TBC Platform website, and/or the like 310. In one embodiment, users may enjoy access to all aspects of the TBC Platform website and/or TBC Platform shopping experience up to the point of requesting a good faith estimate for a product in the TBC Platform catalog 315, at which time the user may be required to complete the full registration process.

Further aspects of the TBC Platform registration process may include sending an e-mail message including an embedded link to the e-mail address provided by the user during the initial phase of the registration process 320. The user may click the embedded link in order to verify the e-mail address and proceed with further registration 325, as shown in one implementation in FIG. 3B. The TBC Platform may display a business data entry form, prompting the user to enter additional business information 327 such as, but not limited to, authorized buyer information (e.g., name, title, etc.), signatory information (e.g., name, title, etc.), D&B number, FED number, EIN number, state resale certificate/license, field/industry of operation, fields/industries of interest, opt-in to alerts, any profile information not entered during the initial registration phase, and/or the like. The TBC Platform may receive these business data inputs 330 and analyze them 332 to determine, among other things, whether any essential and/or required data inputs are missing 334. If so, then the user may be prompted for the entry of any essential inputs 336 before being allowed to proceed with registration and/or TBC Platform site usage. Once all essential inputs have been entered, a determination may be made based on the analysis at 332 as to whether essential and/or other inputs are properly formatted and/or otherwise in an acceptable condition 338. For example, TBC Platform components may analyze a D&B number to ensure that it has the proper number of digits. If any required inputs are improperly formatted, the TBC Platform may prompt the user for re-entry of those inputs 340.

Once all required, properly formatted inputs have been received, the TBC Platform may extract a subset of the entered business data for use in retrieving credit report information and/or other business information pertaining to the business, company, corporation, and/or the like that the TBC Platform user is attempting to register 342. The extracted business data may then be packaged in one or more messages and submitted to one or more credit rating and/or reporting agencies, business information repositories, and/or the like. Some examples of such agencies and/or repositories may include Dunn & Bradstreet, the Better Business Bureau, Moody's, Standard & Poor's, and/or the like. A determination may be made at 345 as to whether report retrieval was successful. If not, then a determination may be made as to whether the registration is temporarily allowable 355. If not, then an error message may be supplied to the user suggesting that he or she try again at a later time, and/or the like 360. In an alternative implementation, the TBC Platform may retry the retrieval one or more times before providing an error message to the user. If the registration is deemed to be temporarily allowable, then the TBC Platform may populate a TBC record and/or user profile and/or company profile with a flag and/or message indicating that the retrieval of a credit and/or other business information report is still pending, provide restricted clearance and/or access for the user, set a reminder for itself to retry retrieval of the credit report, and/or the like 365. If retrieval of the credit and/or other business reports is successful at 345, then the TBC Platform may auto-populate a TBC record with retrieved information, such as one or more credit ratings, business integrity ratings, and/or the like 350. The automatic population of such business information, outside the hands of the user and/or associated company, provides assurance to TBC Platform counterparties looking to engage in transactions with the user and/or company that the business information is legitimate, thus increasing their confidence in engaging in the transaction and increasing the likelihood that the transaction will ultimately be consummated.

In addition to providing transactional counterparties with retrieved business information, credit ratings, and/or the like, the TBC Platform may, in one implementation, analyze retrieved business information in order to determine and/or assign access levels within the TBC Platform, a TBC Platform enforced and/or recommended credit cap, and/or the like 353. For example, in one implementation, the TBC Platform may compare a given company's credit rating with a table of credit ratings and associated credit caps in order to determine an appropriate credit cap to append to the company's TBC record. In another implementation, the TBC Platform may analyze and/or parse a Better Business Bureau business reliability report associated with the registering company to search for the presence of certain keywords, phrases, warnings, flags, and/or the like. A company with a business reliability report matching certain criteria may be restricted from browsing and/or purchasing certain TBC Platform catalog items with a price exceeding some threshold. In still another implementation, the TBC Platform may analyze information received from the Better Business Bureau, a credit rating agency, and/or the like and determine a commercial reliability score based thereon in light of a set of reliability criteria. The commercial reliability score may then be appended and/or incorporated in a business' TBC record.

In some implementations, the TBC Platform my further incorporate ratings, rankings, and/or other scores associated with a TBC Platform participant in that participant's associated TBC record. For example, TBC Platform buyers and sellers may provide satisfaction ratings for transactional counterparties with which they are engaged, and these satisfaction ratings may be incorporated into a reliability score in association with a TBC Platform participant. The TBC Platform may then auto-populate such a score within the participant's TBC record. Other participant information, such as TBC Platform activity, purchase and/or sale behavior, and/or the like may be analyzed and/or incorporated in a TBC record in various embodiments.

The TBC Platform may further request a user to provide a contact roster for association with a company's TBC record 370. The contact roster may comprise a list of e-mail addresses, phone numbers, and/or other contact information for specific individuals and/or TBC Platform users affiliated with the registering company for whom the TBC record is being generated. The contact roster may be employed by the TBC Platform to route company and/or TBC directed communications to specific individuals who are authorized to receive and respond thereto. The contact roster may be appended to the TBC record and, along with the other business information comprising the TBC record, may be persisted in a TBC database 375.

In one implementation, a TBC record designates a company, and not an individual, at the highest level of security responsible for transacting with and within the TBC Platform, effectively limiting risk. A further advantage of such a designation is the amelioration of administrative difficulties associated with employee turnover, as the same company-specific TBC record may persist despite changes in personnel as long as ties to authorized actors within the company are maintained. Authorized actors may be assigned within a TBC record, such as approved buyers and/or authorized signatories.

In one embodiment, the XML for a TBC record may take a form similar to the following example:

<TBC ID = “TBC12345”>

<login_info>

<login> XYZmaster </login>
<password> aq1SW2fr4 </password>

</login_info>
<company_info>

<name> XYZ Stores, Inc. </name>
<address> 537 ABC St., Suite Q </address>
<city> New York </city>
<state> NY </state>
<zip> 10115 </zip>
<phone> (212)555-4371 </phone>
<fax> (212) 555-9821 </fax>
<email> XYZ_master@XYZ.com </email>
<field> Home and Garden Merchandise </field>
<DB_num> 975392761 </DB_num>
<FED_num> 52181 </FED_num>
<EIN_num> 67151548 </EIN_num>
<BBB_ID> 3723AA </BBB_ID>
<resale_cert>

<state> CA </state>
<expiration> 09/2009 </expiration>

<resale_cert>

</company_info>
<user_info>

<registering_user>

<name> Reginald Smith </name>
<title> marketing director </title>
<email> rsmith@xyz.com </email>

</registering user>
<authorized_buyer>

<name> Bob Brown </name>
<title> operations manager </title>
<email> bbrown@xyz.com
<ID> 5421657 </ID>

</authorized_buyer>
<signatory>

<name> Simon Ford </name>
<title> chief financial officer </title>
<email> sford@xyz.com </email>
<ID> 156867 </ID>

</signatory>
<contact_roster> xyzcontacts.xls </contact_roster>

</user_info>
<retrieved_info>

<DB_rating> Good </DB_rating>
<BBB_rating> 4.3/5 </BBB_rating>

</retrieved_info>
<access>

<resale> true </resale>
<credit_cap> $500K </credit_cap>
<site_access> full </site_access>

</access>
<options>

<field_of_interest> glassware, furniture </fields_of_interest>
<opt-ins> sales, home and garden promotions </opt-ins>

</options>

</TBC>

FIG. 4 shows an implementation of logic flow for imparting a buyer TBC record to a seller in one embodiment of TBC Platform operation. The TBC Platform may provide a TBC Platform catalog for display, such as via a TBC Platform website 401. A determination may be made as to whether an indication of interest has been received with respect to a TBC Platform catalog product from a buyer 405. An indication of interest may, for example, comprise a request for a good faith price estimate for the product, a click on the product page, a mouse-over, and/or the like. When an indication of interest has been received, the TBC Platform may query a TBC database to retrieve a TBC record associated with the buyer 410, such as by querying the database based on an ID associated with the logged-in user. A determination is made at 415 as to whether the particular buyer exists in the TBC database, whether the buyer has fully registered, and/or the like. If not, then the buyer may be directed to complete the full registration process (e.g., by proceeding to 320 in FIG. 3A) 420. If the buyer does have a properly registered TBC record, then he or she may be requested to provide a desired payment method for the proposed transaction 425. A determination may be made as to whether or not the proposed transaction is based on a credit purchase 430. If not, then the transaction is marked as a non-credit purchase 433. Otherwise, the TBC Platform may query a buyer's credit cap from the TBC record and/or a buyer profile 435. A determination may be made as to whether the proposed purchase and/or transaction is in compliance with the buyer's credit cap 440 and, if so, the purchase may be marked as being credit compliant prior 445. This allows one or more potential sellers to be quickly and clearly notified of the buyer's credit qualifications in the context of the proposed transaction. If, on the other hand, the buyer's credit cap is exceeded and/or the proposed transaction is otherwise non-compliant, the buyer may be warned and/or prompted as to whether he or she wishes to pursue a credit-based payment for the transaction 450. If the buyer declines to proceed 455 with a credit-based purchase, the proposed transaction may be marked as a non-credit purchase 460 or, alternatively, the buyer may be permitted to void the proposed transaction altogether 462. Should the buyer wish to proceed with a credit-based purchase 455, then the proposed transaction may be flagged for one or more potential sellers as non-compliant with the buyer's credit cap 465. In an alternative implementation, the TBC Platform will forbid a buyer from proceeding with a credit purchase that exceeds the buyer's credit cap.

Once a payment method has been established and the proposed transaction marked based on its compliance with a buyer's credit status, the buyer's TBC record may be collected and prepared for transmission to one or more sellers of the product or products the buyer has indicated interest in 470. Contact and/or other communication information corresponding to one or more sellers may be queried, such as from seller profiles, seller TBC records, and/or the like 475, and a packaged buyer TBC may be provided to the one or more sellers 480. In one implementation, only a subset of a buyer's entire TBC record may be included in the packaged buyer TBC that is provided to the seller. In one implementation, the packaged buyer TBC may take the form of an electronic business card (e.g., vCard format). In another implementation, buyer information contained in the packaged buyer TBC may be used to auto-populate a contact for the buyer in a seller address book, e-mail client, and/or other application (e.g., an address book entry in Microsoft Outlook).

In one embodiment, the buyer TBC may effectuate and/or supply information to auto-fill a web form and/or the like that the buyer may then submit to the seller as part of a transaction proposal, purchase, and/or the like. In various implementation of this embodiment, the buyer may be permitted to edit all auto-filled data fields, a subset of auto-filled data fields, or none of the auto-filled data fields. In one implementation, the TBC record may populate all fields of a web form and/or other transactional article except for the shipping information, which a TBC Platform user may then enter manually.

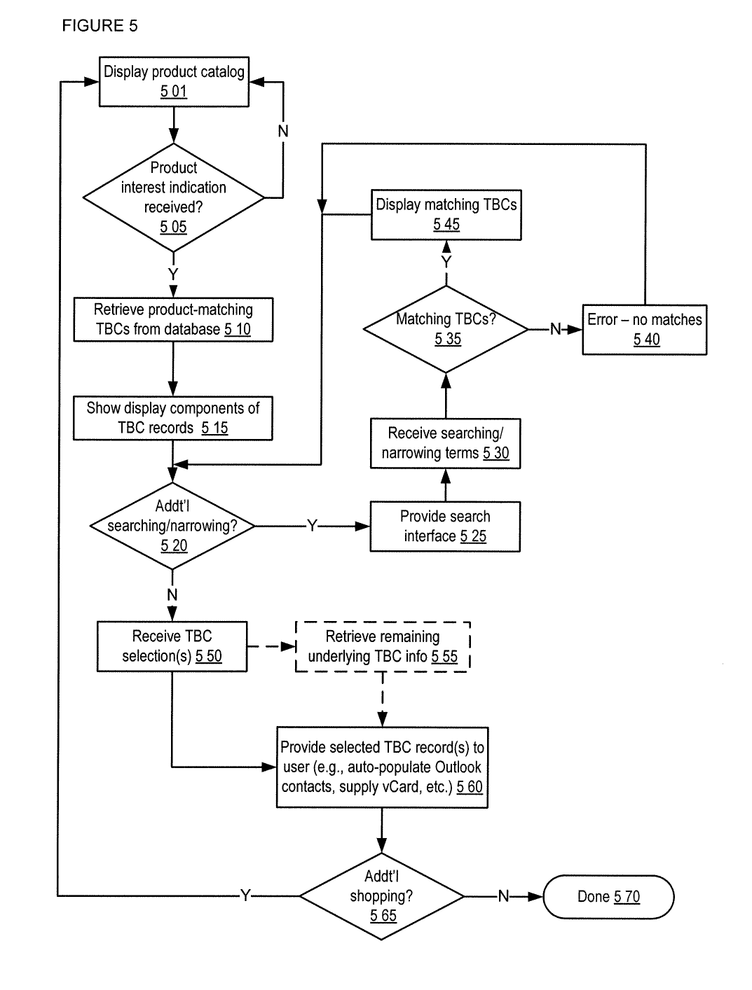

FIG. 5 shows an implementation of logic flow for imparting a seller TBC record to a buyer in one embodiment of TBC Platform operation. A TBC Platform catalog may be displayed at 501, allowing a buyer to browse and/or interact with product listings. If a product interest indication is received 505, product-matching TBC records may be retrieved 510. In one implementation, TBC records may be retrieved for a given product if the companies to which the TBC records belong sell, import, export, manufacture, or are otherwise associated with that product. Retrieved seller TBC records may be analyzed to extract a subset of display components to show to the buyer 515. Display components may, in one implementation, comprise a subset of information from a TBC record that is suitable for initial display to a buyer, such as company name, trademark, contact information, and/or the like. A determination is made and/or an option is offered to the buyer as to whether any additional searching and/or narrowing of seller TBC records is desired 520. If so, then the TBC Platform may provide a search interface whereby a user may enter and/or select terms and/or other criteria with which to filter the TBC records. Searching and/or narrowing terms, such as company name, industry, product types, and/or the like, may be received 530, and a determination made as to whether any further sellers and/or associated TBC records exist matching the specified terms and/or criteria 535. If not, then an error message may be returned to the buyer 540. Otherwise, the filtered set of matching seller TBC records may be provided for display 545.

When the field of seller TBC records has been sufficiently narrowed, the buyer may be requested to select one or more sellers and/or TBC records from those remaining. The buyer's TBC selections are received 550, and the corresponding TBC records are then provided to the buyer 560. In one implementation, remaining and/or underlying TBC record information, not included in the display components shown at 515, may be retrieved from the TBC record for inclusion in the TBC package supplied to the buyer. In one implementation, only a subset of a seller's entire TBC record may be included in the packaged seller TBC. In one implementation, the packaged seller TBC may take the form of an electronic business card (e.g., vCard format). In another implementation, seller information contained in the packaged seller TBC may be used to auto-populate a contact for the seller in a buyer e-mail client or application, such as Microsoft Outlook.

In some implementations, an electronic image of a business card carrying information extracted from a TBC record corresponding to a seller of a product may be embedded on a web page featuring that product or similar products within a TBC Platform website and/or catalog webpage. In one implementation, a webpage featuring a particular class of products may display TBC-based business card images for a plurality of businesses selling and/or otherwise associated with that class of products.

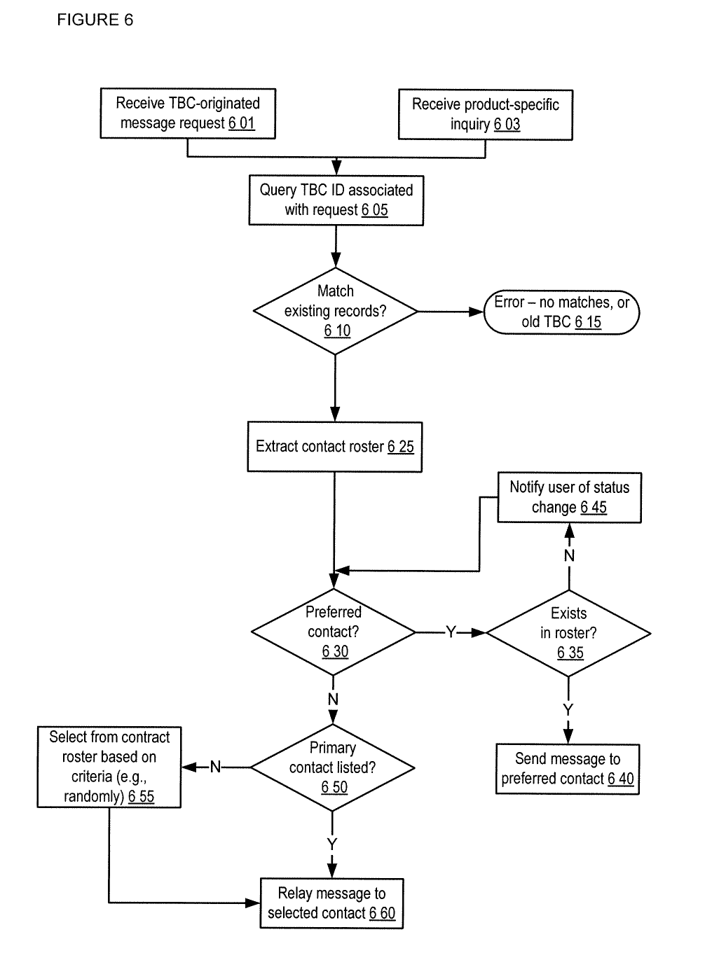

FIG. 6 shows an implementation of logic flow for connecting TBC-originated messages and/or inquiries to specific recipients in one embodiment of TBC Platform operation. In the illustrated implementation, a TBC-originated message request may be received by the TBC Platform (e.g., a TBC Platform user may click a link on a TBC vCard to send a message to the company corresponding to that TBC vCard) or the TBC Platform may receive a product-specific inquiry (e.g., a TBC Platform user may submit a request for a good-faith estimate from the TBC Platform catalog via a TBC Platform website). In alternative implementations, any communication request based on and/or originating from a TBC may engender a similar process for determining a specific recipient for the communication. The TBC Platform may query a TBC ID associated with the request 605 and check if the ID matches any existing TBC records 610. If not, such as if the ID is corrupted, if the TBC used to originate the message is old or expired, and/or the like, then an error message may be returned to the message originator 615. On the other hand, if a match exists, then the TBC Platform may extract a contact roster from the information contained in the TBC record 620. The contact roster may be updated by an authorized member of a company associated with a given TBC, and thus should represent the most up-to-date list of authorized recipients for TBC-originated messages. A determination may be made as to whether the message originator has a preferred contact he or she would like to reach 630. If so, then a determination is made as to whether that preferred contact exists within the contact roster 635. If so, then the message is sent to the preferred contact 640. Otherwise, the message originator may be notified of the status change for his or her preferred contact 645 (i.e., that the preferred contact no longer appears on the contact roster for that company's TBC). If no preferred contact is specified, then a determination may be made as to whether there exists a primary contact listed in the roster and/or any other assignment of contact priority for the contacts listed in the contact roster 650. In one implementation, contacts within the contact roster may be scored, rated, and/or ranked, with contact priorities based thereon. If a primary contact is listed, then that contact may be selected as the recipient and the message may be sent thereto 660. Otherwise, a contact may be selected from the contact roster based on some other criteria 655. In one implementation, if no primary contact exists, a contact may be selected randomly from the contact roster for receipt of the message. In another implementation, contacts within the contact roster may be ordered and, in the absence of a primary contact, a given message may be sent to the next contact in order in the list following the most recent previous message recipient.

### Trade Business Card Platform User Interface

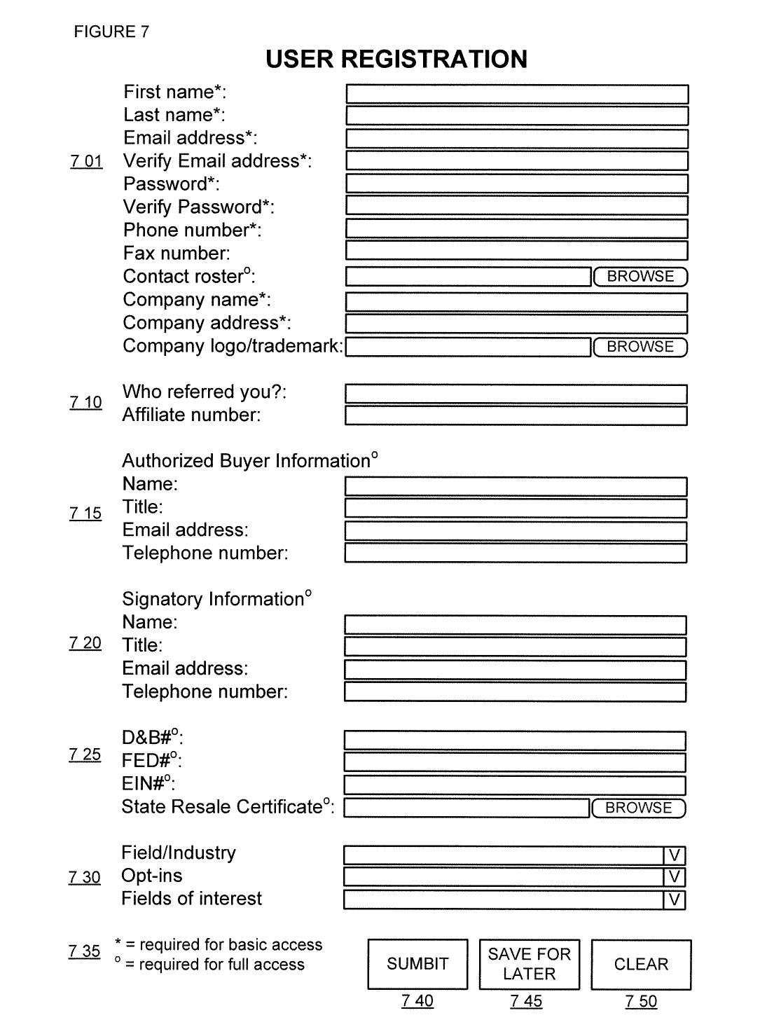

FIG. 7 shows an implementation of a registration user interface in one embodiment of TBC Platform operation. A TBC Platform registration user interface may comprise a plurality of fields in which a user may enter business and/or personal information in order to initiate the TBC generation process and be allowed a greater degree of access to TBC Platform features and/or functionality. The illustrated implementation shows fields for entering basic profile information 701 such as, but not limited to, a user's first and last name, a valid e-mail address (with verification), a password (with verification), a phone number, fax number, a company name, and a company address. There are also fields admitting uploads of a contact roster and an image of a company logo or trademark. In an alternative implementation, a company roster may be entered manually and/or constructed directly via the TBC Platform registration process. The registration UI further includes fields admitting information about who referred the user to the website and an affiliate number 710; authorized buyer information 715; signatory information 720; business identifiers for submission to third party business information services and/or agencies, as well as a field to upload state resale certification information 725; and information about a business' field of operation, fields of interest, and opt-in selections (e.g., for notifications, advertisements, and/or the like) 730. As indicated by the key at 735, some of the fields may be required for basic access to TBC Platform features and/or functionality, while additional fields may be required for full access, and some fields may be completely optional. Which fields are made optional and which are required for basic or full access may be determined by the particular desires and/or requirements of a TBC Platform administrator in a particular implementation. Finally, the registration user interface includes buttons to submit the registration information 740, to save the entered registration information to be completed at a later time 745, and to clear the entered information 750.

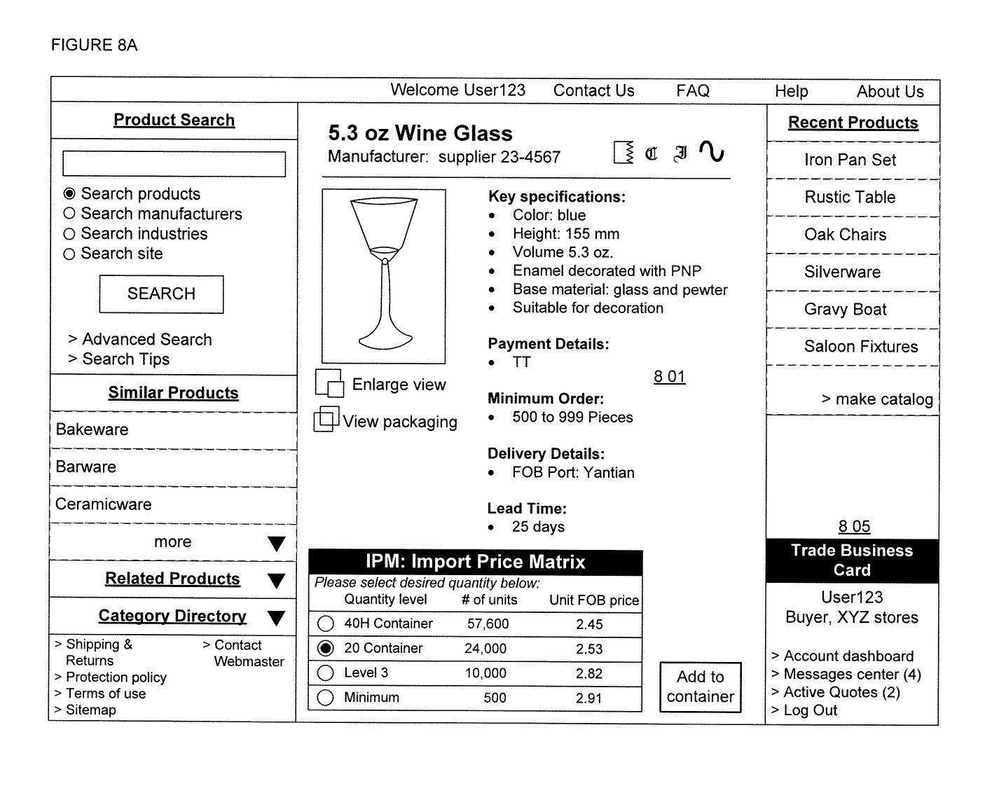

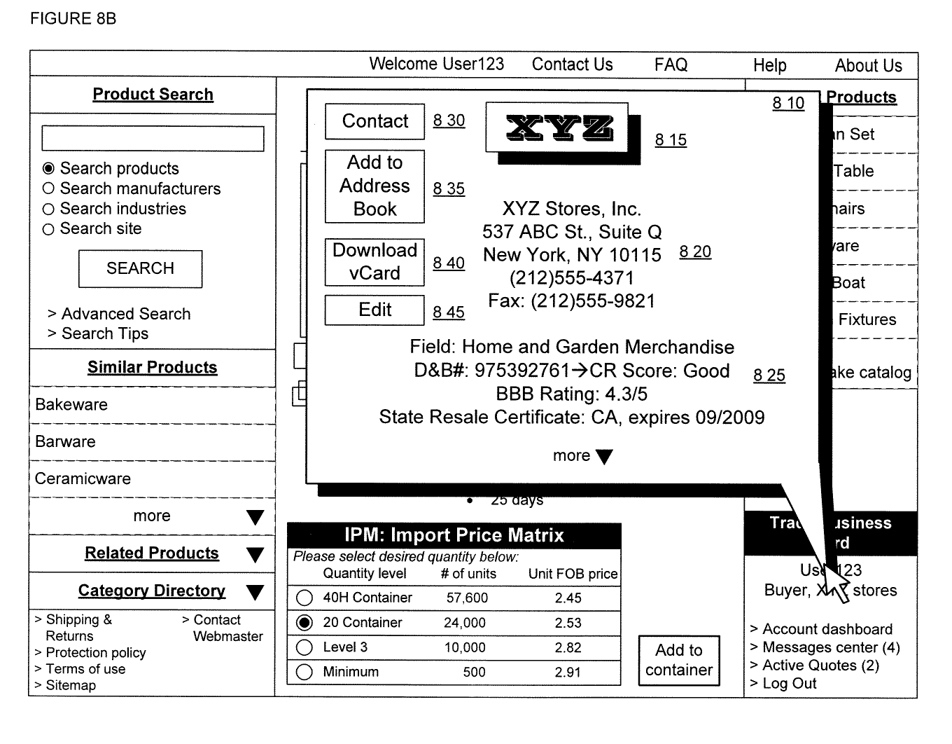

FIGS. 8A-B show an implementation of a TBC Platform catalog page and TBC electronic business card UI in one embodiment of TBC Platform operation. In FIG. 8A, an exemplary page from a TBC Platform catalog is shown, showcasing a wine glass product entry 801. The page also includes a TBC record UI area 805, showing a subset of TBC record information for the user viewing the TBC Platform catalog page. In alternative implementations, the displayed TBC record UI area may be associated with a TBC record corresponding to one or more sellers associated with the displayed catalog product. In still other implementations, TBC record UI areas and/or TBC record based electronic business cards may be displayed in conjunction with e-mails or other electronic messages, user profile pages, or may be embedded in a variety of other area within a TBC Platform website and/or catalog webpage as needed within a particular implementation of the TBC Platform. In the illustrated implementation, the TBC record UI area serves as a link to a more detailed TBC record UI feature, as shown in FIG. 8B. By clicking on, mousing over, and/or otherwise interacting with the TBC record UI area 805, the user may cause a TBC UI electronic business card 810 to appear, showing more information drawn from the TBC record. Here, the electronic business card shows a business logo image 815; business name and contact information 820; additional business information 825 such as field of operation, credit rating, commercial reliability score(s), third party business information access ID(s), resale certification(s), and/or the like. The illustrated implementation also includes buttons allowing a user to contact the business 830, add the business information shown in the TBC record UI 810 to an address book 835, download a vCard 840, and to edit 845 the information contained in the TBC record and/or shown in the TBC record UI 810. The edit button 845 may not be present if the user is not viewing the TBC record UI corresponding to his or her own company and/or if he or she is otherwise unauthorized to edit the TBC record and/or TBC record UI.

### Trade Business Card Platform

Unlike the Trade Business Card Platform, current B2B portals do not offer a completely integrated online trade transaction process; i.e., none of the B2B portals offer an end-to-end (E2E) electronic cross-border transaction mechanism that facilitates the navigation of extensive import-export bureaucracies and processes. Worse still, each country's various trade regulations and/or restrictions vary depending on the country with which the trade transaction is taking place. As such, each country-to-country transaction will have a unique set of trade regulations and/or restrictions. This results in an unimaginable number of country-to-country trading pairs of trade regulations and/or restrictions with which trading partners must be familiar in order to complete a transaction. As a result, even if a user finds a trading partner that offers goods in which they are interested, there is no easy way for that user to know what the actual cost of the transaction will be as the transaction costs of the administrational, customs, duties and/or other related costs of the trade are difficult to discern and surmount. Even if the user can find out what trade restrictions apply to a particular country-to-country transaction, the labyrinth path of procuring the right forms and properly filing such forms is circuitous at best. As a result, global trading partners will engage in transactions with relatively few trading partners in relatively few regions; it is just too difficult for even sophisticated trading businesses to become savvy in more than a relative few country-to-country pairings of trade processes, regulations and/or restrictions. As difficult as the import-export process is for large and sophisticated trading entities, it is all the more intimidating for small-to-mid-sized-enterprises (SMEs). As a result of such complexity, various consultants and trade intermediaries offer their services to facilitate global trades, resulting in added costs, intermediary steps, inefficiencies, and/or delays. Furthermore, current B2B portals still require a high level of expert knowledge of the export-import processes, are not consistently and/or systematically integrated with third party service providers and are not integrated between the trading parties. The Trade Business Card Platform overcomes these failings.

### Market Creation

Through its various components, the cross-border Trade Business Card Platform creates new markets by generating and facilitating three stages of a cross-border trade transaction: identification, selection and execution. In one embodiment, the Trade Business Card Platform manages the transaction by: creating a transaction “template” based on transaction information (i.e., HS product code, ISO country code, etc), alerting the buyer to potential problem areas, and updating of important upcoming dates and actions. The Trade Business Card Platform creates all the required documents, integrates all events, including the service providers, and allows both parties to track the status of the transaction on-line at any time.

In one embodiment, the Trade Business Card Platform provides the user with a template to ensure all pertinent transaction information is detailed, so that roles and responsibilities of the trading partners are clearly defined and transparent prior to engagement. As such, the proper template will be chosen based on the types of goods involved in the transaction, the nature of the trading partners relationship, the source and destination countries for the transaction (and any intermediary countries), etc. Through an elegant user interface, buyers can input how and by when they desire their goods, as well as designate/request additional services like insurance coverage and inspection. Unlike competing B2B sites, rather than merely showing the quoted price, buyers on the Trade Business Card Platform will be able to see indications of a variety of expenses associated with the transaction, such as: the total cost of goods, including foreign exchange costs, any additional services, transportation, customs duties and incremental taxes. In this way, buyers may be able to drag and drop quotations into a comparison matrix which will provide total transparency across a range of criteria including quoted price, total cost of goods, credit worthiness and service quality history.

The Trade Business Card Platform has many numerous and revolutionary components to facilitate cross-border transactions, such as, but not limited to: a classification taxonomy, multi-lingual facilities, a search-enhancing thesaurus, an acquisition matrix core, a logistical fulfillment matrix, payment facilitator, an elegant User Interface (UI), and/or the like.

### Taxonomy Classifier

The cross-border Trade Business Card Platform includes a taxonomy classifier that enables sellers and buyers to generate and use attribute and facet schemas. Thus, the taxonomy classifier generates classification taxonomies. The classification taxonomy is used by the Trade Business Card Platform to provide a mechanism for global trading partners to identify, match, search, select, etc. goods and/or services. The taxonomy provides more information than merely listing a series of product specifications for a specific good and/or service. The classification taxonomy component includes schemas to map to any type of product and/or service category and thereby provide meaningful and interrelated attributes and facets that will allow trading partners to identify desired and consequential features of interest with accuracy, ease and precision. Further, the taxonomy may have numerous language translations related to the facets, attributes, goods and/or services, and as such it provides immediate and accurate translations for product features and feature sets.

### Trade Business Card Platform Matrix Engine

In addition, the Trade Business Card Platform has an intelligent business-rules driven engine matrix. The Trade Business Card Platform matrix engine generates, facilitates and employs an acquisition matrix, a logistical fulfillment matrix, and a payment; this allows the Trade Business Card Platform to provide trading partners with pricing, delivery and fulfillment effecting information based on the user's location, the location of the goods and/or services, and the types of goods and/or services. The Trade Business Card Platform engine matrix is a business-rules driven engine having multidimensional and interrelated rules and data sets that uses a buyer's information (e.g., location, type of entity, financial accounts and information, etc.), product information (e.g., type of goods and/or services, attributes and facets, location of the goods and/or services, availability of the goods and/or services, etc.), seller's information (e.g., location, type of entity, etc.), country regulations (e.g., import/export restrictions, regulations, duties, tariffs, financial accounts and information, etc.), intermediary information (e.g., costs, availability, etc. of couriers, carriers, freight agent, banks, etc.) and other pertinent-to-the-transaction criteria to provide both the buyer and seller with salient transaction information. Acquisition Matrix

Thus, when the Trade Business Card Platform engine matrix is employed to facilitate the mechanics of transaction acquisition, the acquisition matrix is employed. The acquisition matrix employs interrelated rules and data sets pertinent to connecting buyers and sellers (i.e., pertinent to transaction acquisition). As such, the Trade Business Card Platform engine matrix employs the acquisition matrix to facilitate users searching and identifying specific goods for a total-lowest-cost (i.e., taking transactional costs into account); users can search and identify such goods from any and all sellers, world-wide, within specified time and/or cost constraints. As such, users are able to see and/or establish the total time it will take to complete and receive any requested goods. In one embodiment, users are provided with significant flexibility to configure a transaction to meet their needs and priorities. For example, a user may be able to use slider widgets to increase the speed with which they want too receive the goods; as a result, the user will see (dynamically updating on their screen) the lowest price offerings that can received within the designated time frame. In another embodiment, the user may employ a slider to decrease the cost of an item, which may increase its shipping time. The system also may be configured to dynamically update a listing of available products that meet a user's designated transaction criteria and in some implementations specifically omit those products that do not meet a user's criteria. For example, goods having availability lag times, that are in countries with customs delays for that type of good, and that are above the threshold time set by the slider will fail to match the slider generated query criteria. This allows a user to make an informed decision and enter into a transaction that suits their cost and time requirements in an elegant manner. In yet another embodiment, the Trade Business Card Platform may be configured to discern differences in currency as between buyers and sellers and automatically represent all goods in the user's native currency. Logistical Fulfillment Matrix

Further, when the Trade Business Card Platform engine matrix is employed to facilitate the mechanics of logistical fulfillment, a logistical fulfillment matrix is employed. The logistical fulfillment matrix employs interrelated rules and data sets pertinent to connecting the transfer of goods from seller to buyer (i.e., pertinent to logistical fulfillment). As such, the Trade Business Card Platform engine matrix employs the logistical fulfillment matrix to facilitate the identification, retrieval, population and provision of approvals, forms, and/or the like based on intermediary information (e.g., costs, availability, etc. of couriers, carriers, freight agent, banks, etc.) and national regulations. In one embodiment, the logistical fulfillment matrix will determine and pre-populate the appropriate forms for couriers, import/export regulations, declarations, customs that are required to facilitate the transaction for the type of goods in question and provide all such requisite regulatory materials to the parties. In another embodiment, previous transactions are used to pre-populate forms for 1-click cross-border transactions. Payment Matrix

In an implementation, when the Trade Business Card Platform engine matrix is employed to facilitate the mechanics of payment, the payment matrix is employed. The payment matrix employs interrelated rules and data sets pertinent to the exchange of payments and transfer of financial instrument as between seller, buyer and any intermediary financial institutions (i.e., pertinent to payment). As such, the Trade Business Card Platform engine matrix employs the payment matrix to facilitate the identification of acceptable forms of monetary transfer, the connection of buyer/seller financial information (e.g., bank accounts, credit cards, native currency, etc.) to any intermediary financial vehicles, security of payments (e.g., through letters of credit, escrow accounts, security agreements, etc.), and/or the like based on intermediary financial information (e.g., cost of money, interest rates, availability, banks, etc.) and country regulations. In one embodiment, the payment matrix will determine and pre-populate the appropriate financial instruments for the goods in question and provide all the requisite invoicing information to the parties. In another embodiment, previous outside financial agents and/or institutions are employed. In yet another embodiment, the Trade Business Card Platform may be configured to discern differences in currency as between buyers and sellers and automatically render all financial transactions in the user's native currency.

In an alternative embodiment, the Trade Business Card Platform may be configured to facilitate transactions in surplus goods. In another embodiment, the Trade Business Card Platform allows global traders to negotiate in real-time between in a reverse bidding system. In another embodiment, global traders may use instant messenger chat where they can talk to each other (in approximately 80 different languages), wherein the taxonomy component provides translations, as well as handles homonym or synonyms issues that may arise. For example, The taxonomy component is able to discern that “lend” has different meanings in different countries. In one embodiment, all user transactions are archived and thus may form the basis of future transactions and courses of dealings between global traders. In one embodiment, the Trade Business Card Platform provides the fastest way to route an item from a source to a destination. In one embodiment, search results for an item may be sorted by carriers, method of transportation (ship, container, insurance, warehousing), refrigeration, perishable, livestock, etc. In another embodiment, the Trade Business Card Platform allows users to engage in “what if” analysis (e.g., to see how reducing the desired price for an item affects delivery times). In another embodiment, bidding on an item includes the added value price (including total cost with shipping and handling). In one embodiment, the Trade Business Card Platform tracks national levels of sales of types of goods; in an alternative embodiment the Trade Business Card Platform tracks international currents of sales of types of goods. In one embodiment, users may ask the system questions and in turn, the system may generate interactive responses given based taxonomy recognition of the question and mapping to a Frequently asked questions component. In another embodiment, the Trade Business Card Platform will discern differences in currency as between buyers and sellers and automatically represent all aspects of a transaction in the user's native currency.

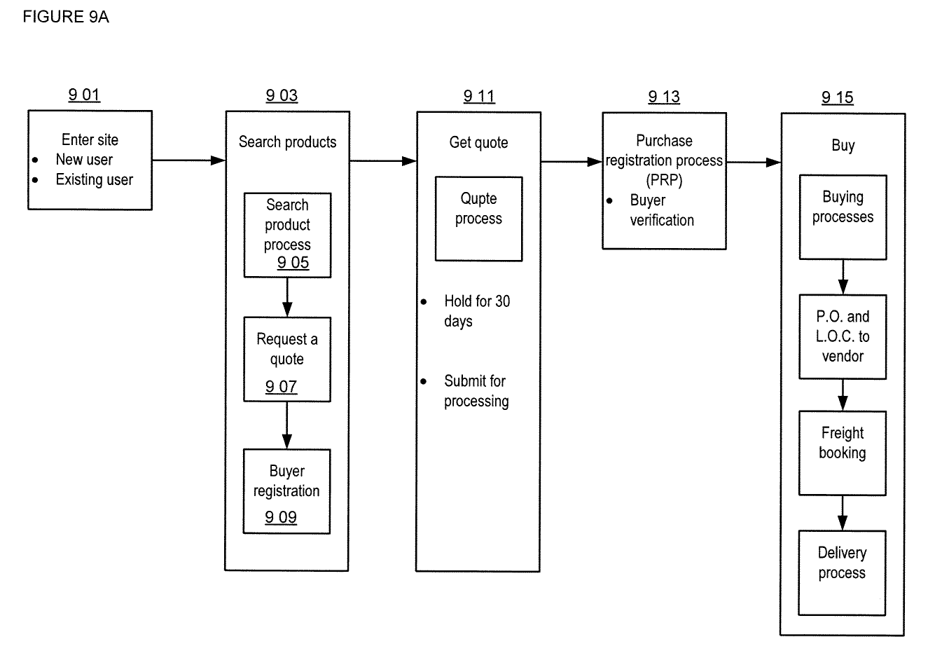

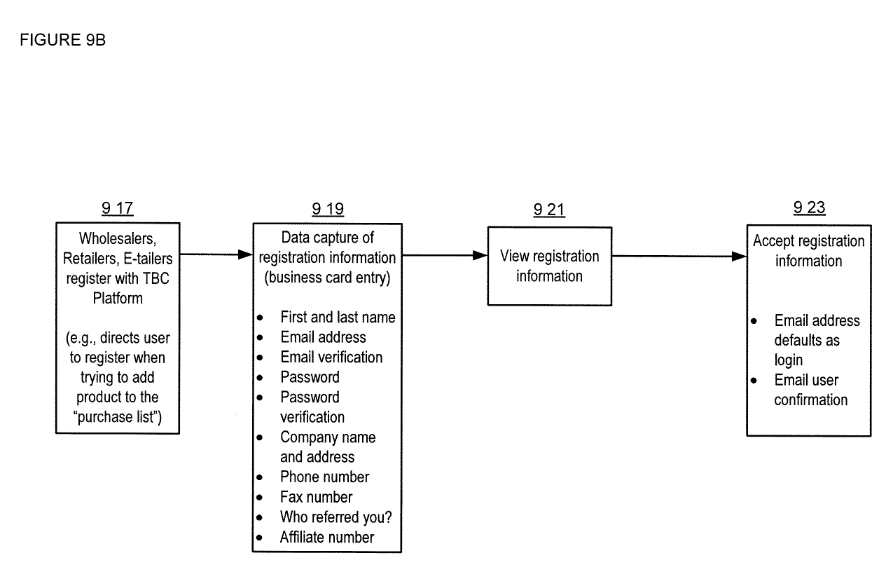

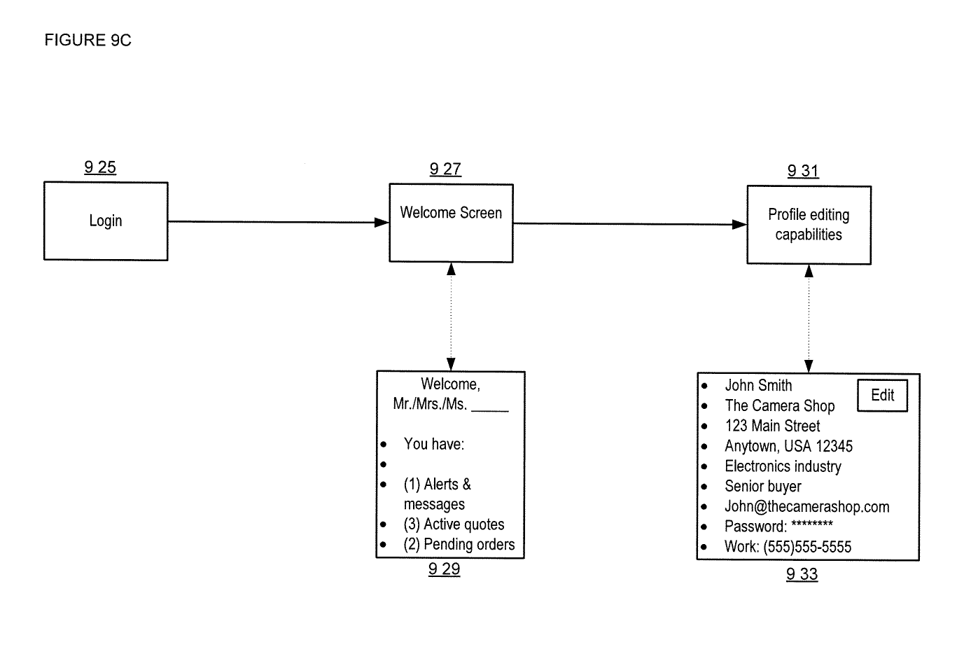

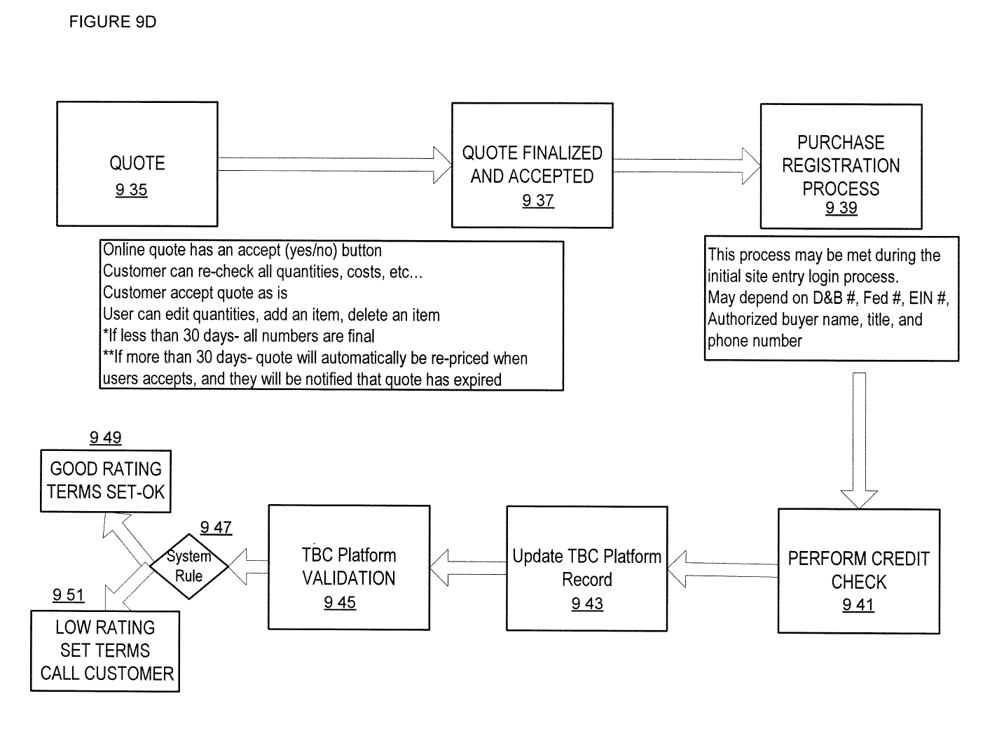

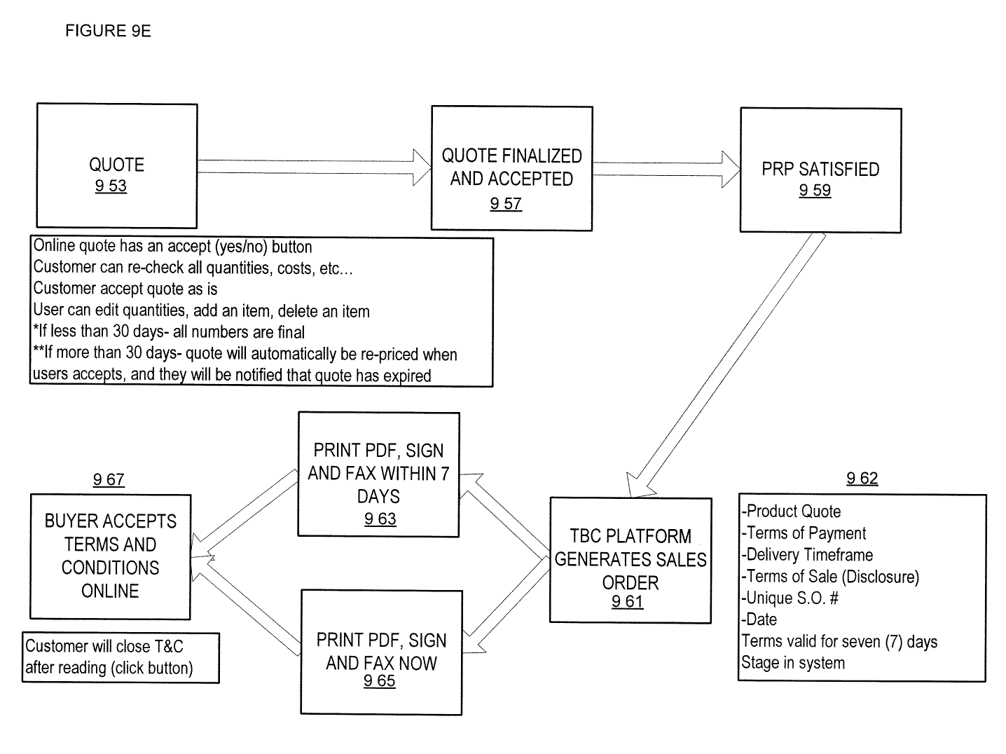

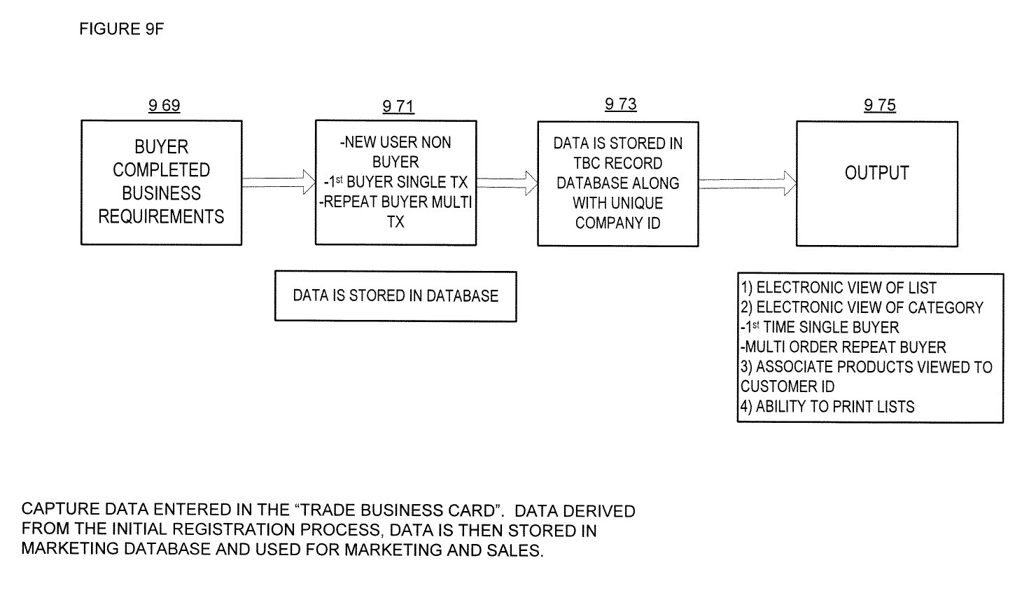

FIGS. 9A-F illustrate further aspects of a TBC in the context of an online import-export trading facility and/or TBC Platform website in another embodiment of TBC Platform Operation. FIG. 9A shows an implementation of logic flow for product purchasing in one embodiment of TBC Platform operation. A new or existing user may enter a TBC Platform catalog website 901 and search products 903 therein. The TBC Platform may implement a product searching process 905, such as that described in related non-provisional patent application Ser. No. 11/864,900 filed Sep. 28, 2007, entitled, “Apparatuses, Methods and Systems for a Transactional Facilitation Portal”; non-provisional patent application Ser. No. 11/864,902 filed Sep. 28, 2007, entitled, “APPARATUSES, METHODS AND SYSTEMS FOR A TRANSACTIONAL PARAMETER SELECTION INTERFACE”; non-provisional patent application Ser. No. 11/864,903 filed Sep. 28, 2007, entitled, “APPARATUSES, METHODS AND SYSTEMS FOR A PRODUCT MANIPULATION AND MODIFICATION INTERFACE”; and non-provisional patent application Ser. No. 11/864,905 filed Sep. 28, 2007, entitled, “Apparatuses, Methods and Systems for a Project and Transactional Parameter Based Search Engine,” all of which are incorporated herein by reference. A buyer may be required to complete an initial phase of a registration process prior to being allowed to engage the searching process 905. Once a buyer finds a product of interest, he or she may request a quote 907, at which time he or she may be prompted to complete additional registration 909. Once the buyer has fully registered, a quote may be acquired 911 and a purchase registration process (PRP) undertaken 913, including buyer verification. Finally, the buyer is allowed to proceed with buying the product 915.

FIG. 9B shows an implementation of logic flow for user registration in one embodiment of TBC Platform operation. TBC Platform participants, such as wholesalers, retailers, e-tailers, and/or the like may be prompted to register with the TBC Platform 917, such as when they attempt to add one or more products to a “purchase list”, receive a good-faith estimate or quote, and/or the like. The registration process engenders a data capture of a variety of registration and/or business information 919, which may form the basis of a TBC record. Once entered, the registration may be provided for viewing by the registering user and/or a TBC administrator 921, and an option provided as to the acceptability of the entered registration information 923. If acceptable, an entered e-mail address may serve as a user login, and/or the user may be sent an e-mail message containing an embedded electronic link to be clicked for the purpose of user verification and/or e-mail address confirmation.

FIG. 9C shows an implementation of logic flow and UI components for user login in one embodiment of TBC Platform operation. A user may enter login information, password, and/or the like 925 to gain access to the TBC Platform catalog and/or website. In response, the TBC Platform may supply a welcome screen 927, which may include a notice of recent user activity and/or notifications such as alerts and messages, active quotes, pending orders, and/or the like 929. The TBC Platform may also provide the user with profile editing capabilities 931. An example of a TBC record UI showing some data contained in a TBC record is shown at 933, including an “Edit” button to enable the user to edit the TBC record data. In one implementation, a user's authorization status may be queried prior to allowing the user to edit TBC record data (e.g., a user may only be allowed to edit TBC record data for a company for which the particular user is an employee). In some implementations, only a subset of TBC record data may be edited by the user.

FIG. 9D shows an implementation of logic flow for transaction request processing in one embodiment of TBC Platform operation. A buyer may receive and/or interact with an initial quote for a product 935. A certain degree of flexibility may be provided for the buyer to modify purchase parameters, negotiate purchase terms and/or prices, vary quantities, and/or the like, after which the quote may be finalized and/or accepted by the buyer 937. When a quote has been accepted, the user and/or TBC Platform may undertake a PRP 939 to ensure that the purchase is compliant with TBC Platform rules, regulations, policies, restrictions, and/or the like. For example, the TBC Platform may check that the buyer is an authorized buyer, that the scale of the purchase is within the access and/or credit level limits of the buyer, and/or the like. The TBC Platform may perform a credit check on the buyer 941 in order to determine whether the proposed transaction is acceptable in light of the buyer's credit status and/or situation. The credit check and/or PRP may, in one implementation, draw on information already retrieved and stored in a buyer TBC record. A TBC Platform record, such as a TBC record or transaction-specific record, may be updated with the results of the PRP and/or credit check 943 and a validation procedure undertaken 945 to determine whether the proposed transaction is allowable based on one or more system rules 947. A system rule may, for example, comprise a requirement that a price for a proposed transaction be less than a buyer's credit cap. If a good rating is obtained by implementation of the system rule(s) 947, then terms are set and the transaction is allowed to proceed 949. Otherwise, a low rating may yield different terms and/or one or more customers may need to be contacted with regard to a non-ideal and/or non-compliant proposed transaction 951.

FIG. 9E shows another implementation of logic flow for transaction processing in another embodiment of TBC Platform operation. A buyer may again receive and/or interact with an initial quote for a product 953 and, after quote terms have been finalized, may accept the quote 955. The accepted quote may then be subject to a TBC Platform PRP 939 to ensure that the purchase is compliant with TBC Platform rules, regulations, policies, restrictions, and/or the like. The TBC Platform may subsequently generate a sales order 961 for the proposed transaction, which may include a variety of information such as that shown at 962. The buyer may then be requested and/or required to print a copy of the sales order (e.g., a Portable Document Format file), sign the printed copy, and return the signed copy by fax, by mail within a specified time period (e.g., seven days), and/or the like (963, 965). Terms and conditions for the sale may then be supplied to the buyer to accept online, such as via an electronic message and/or a TBC Platform website 967.

FIG. 9F shows an implementation of logic flow for TBC record processing in one embodiment of TBC Platform Operation. A buyer may input required business information 969, such as during a TBC Platform registration procedure. A TBC Platform may determine, note, and/or update a TBC record depending on whether the buyer is a new user and/or non-buyer (e.g., the user may register with the TBC Platform solely to sell products and not to buy), a first time buyer engaging in a single transaction, a repeat buyer engaging in multiple transactions, and/or the like 971. This data, along with other entered business information, may be stored in association with a unique company ID in a TBC record and/or TBC record database 973. Subsequently, the TBC Platform may provide output content to the buyer and/or to other TBC Platform participants based on TBC record contents. For example, depending on whether the buyer is a new user, a buyer or non-buyer, a repeat buyer, and/or the like, the TBC Platform may engage the user with different, tailored marketing outputs, offers, sale notices, advertisements, and/or the like. The user's TBC record may thus serve as an informational foundation for marketing and/or other information distribution programs and services.

### Trade Business Card Platform Controller

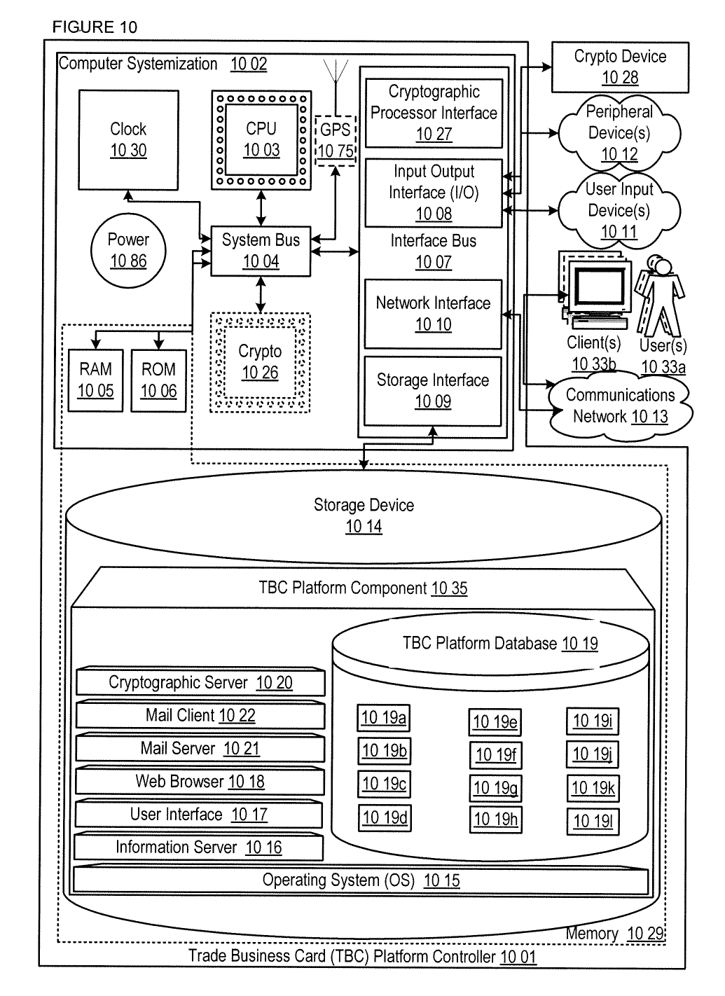

FIG. 10 of the present disclosure illustrates inventive aspects of a Trade Business Card Platform controller 1001 in a block diagram. In this embodiment, the Trade Business Card Platform controller 1001 may serve to aggregate, execute, generate, identify, instruct, match, process, search, store, select serve, and/or facilitate interactions with a computer through for cross-border transactions, and/or other related data.

Typically, users, which may be people and/or other systems, engage information technology systems (e.g., commonly computers) to facilitate information processing. In turn, computers employ processors to process information; such processors are often referred to as central processing units (CPU). A common form of processor is referred to as a microprocessor. CPUs use communicative signals to enable various operations. Such communicative signals may be stored and/or transmitted in batches as program and/or data components facilitate desired operations. These stored instruction code signals may engage the CPU circuit components to perform desired operations. A common type of program is a computer operating system, which, commonly, is executed by CPU on a computer; the operating system enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through a database program. Information technology systems provide interfaces that allow users to access and operate various system components.

In one embodiment, the Trade Business Card Platform system controller 1001 may be connected to and/or communicate with entities such as, but not limited to: one or more users from user input devices 1011; peripheral devices 1012; a cryptographic processor device 1028; and/or a communications network 1013.

Networks are commonly thought to comprise the interconnection and interoperation of clients, servers, and intermediary nodes in a graph topology. It should be noted that the term “server” as used throughout this disclosure refers generally to a computer, other device, program, or combination thereof that processes and responds to the requests of remote users across a communications network. Servers serve their information to requesting “clients.” The term “client” as used herein refers generally to a computer, other device, program, or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The Trade Business Card Platform system controller 1001 may be based on common computer systems that may comprise, but are not limited to, components such as: a computer systemization 1002 connected to memory 1029.

### Computer Systemization

A computer systemization 1002 may comprise a clock 1030, central processing unit (CPU) 1003, a read only memory (ROM) 1006, a random access memory (RAM) 1005, and/or an interface bus 1007, and most frequently, although not necessarily, are all interconnected and/or communicating through a system bus 1004. Optionally, the computer systemization may be connected to an internal power source 1086. Optionally, a cryptographic processor 1026 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s). The CPU interacts with memory through signal passing through conductive conduits to execute stored signal program code according to conventional data processing techniques. Such signal passing facilitates communication within the Trade Business Card Platform system controller and beyond through various interfaces. Should processing requirements dictate a greater amount speed, parallel, mainframe and/or super-computer architectures may similarly be employed. Alternatively, should deployment requirements dictate greater portability, smaller Personal Digital Assistants (PDAs) may be employed.

### Power Source

The power source 1086 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1086 is connected to at least one of the interconnected subsequent components of the Trade Business Card Platform system thereby providing an electric current to all subsequent components. In one example, the power source 1086 is connected to the system bus component 1004. In an alternative embodiment, an outside power source 1086 is provided through a connection across the I/O 1008 interface. For example, a USB and/or IEEE 1394 connection carries both data and power across the connection and is therefore a suitable source of power.

### Interface Adapters

Interface bus(ses) 1007 may accept, connect, and/or communicate to a number of interface adapters, conventionally although not necessarily in the form of adapter cards, such as but not limited to: input output interfaces (I/O) 1008, storage interfaces 1009, network interfaces 1010, and/or the like. Optionally, cryptographic processor interfaces 1027 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1009 may accept, communicate, and/or connect to a number of storage devices such as, but not limited to: storage devices 1014, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1010 may accept, communicate, and/or connect to a communications network 1013. Through a communications network 113, the Trade Business Card Platform system controller is accessible through remote clients 1033b (e.g., computers with web browsers) by users 1033a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1010 may be used to engage with various communications network types 1013. For example, multiple network interfaces may be employed to allow for the communication over broadcast, multicast, and/or unicast networks.

Input Output interfaces (I/O) 1008 may accept, communicate, and/or connect to user input devices 1011, peripheral devices 1012, cryptographic processor devices 1028, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set 145, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 1011 may be card readers, dongles, finger print readers, gloves, graphics tablets, joysticks, keyboards, mouse (mice), remote controls, retina readers, trackballs, trackpads, and/or the like.

Peripheral devices 1012 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the Trade Business Card Platform system controller may be embodied as an embedded, dedicated, and/or monitor-less (i.e., headless) device, wherein access would be provided over a network interface connection.

Cryptographic units such as, but not limited to, microcontrollers, processors 1026, interfaces 1027, and/or devices 1028 may be attached, and/or communicate with the Trade Business Card Platform system controller. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 40 MHz Roadrunner 184.

### Memory

Generally, any mechanization and/or embodiment allowing a processor to affect the storage and/or retrieval of information is regarded as memory 1029. However, memory is a fungible technology and resource, thus, any number of memory embodiments may be employed in lieu of or in concert with one another. It is to be understood that the Trade Business Card Platform system controller and/or a computer systemization may employ various forms of memory 1029. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 1029 will include ROM 1006, RAM 1005, and a storage device 1014. A storage device 1014 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); an array of devices (e.g., Redundant Array of Independent Disks (RAID)); and/or other devices of the like. Thus, a computer systemization generally requires and makes use of memory.

### Component Collection

The memory 1029 may contain a collection of program and/or database components and/or data such as, but not limited to: operating system component(s) 1015 (operating system); information server component(s) 1016 (information server); user interface component(s) 1017 (user interface); Web browser component(s) 1018 (Web browser); database(s) 1019; mail server component(s) 1021; mail client component(s) 1022; cryptographic server component(s) 1020 (cryptographic server); the Trade Business Card Platform system component(s) 1035; and/or the like (i.e., collectively a component collection). These components may be stored and accessed from the storage devices and/or from storage devices accessible through an interface bus. Although non-conventional program components such as those in the component collection, typically, are stored in a local storage device 1014, they may also be loaded and/or stored in memory such as: peripheral devices, RAM, remote storage facilities through a communications network, ROM, various forms of memory, and/or the like.

### Operating System

The operating system component 1015 is an executable program component facilitating the operation of the Trade Business Card Platform system controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh OS, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the Trade Business Card Platform system controller to communicate with other entities through a communications network 1013. Various communication protocols may be used by the Trade Business Card Platform system controller as a subcarrier transport mechanism for interaction, such as, but not limited to: multicast, TCP/IP, UDP, unicast, and/or the like.

### Information Server

An information server component 1016 is a stored program component that is executed by a CPU. The information server may be a conventional Internet information server such as, but not limited to Apache Software Foundation's Apache, Microsoft's Internet Information Server, and/or the. The information server may allow for the execution of program components through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the Trade Business Card Platform system controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the Trade Business Card Platform system database 1019, operating systems, other program components, user interfaces, Web browsers, and/or the like.

Access to the Trade Business Card Platform system database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the Trade Business Card Platform system. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the Trade Business Card Platform system as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, Microsoft's Windows XP, or Unix's X-Windows provide a baseline and means of accessing and displaying information graphically to users.

A user interface component 1017 is a stored program component that is executed by a CPU. The user interface may be a conventional graphic user interface as provided by, with, and/or atop operating systems and/or operating environments such as Apple Macintosh OS, e.g., Aqua, GNUSTEP, Microsoft Windows (NT/XP), Unix X Windows (KDE, Gnome, and/or the like), mythTV, and/or the like. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 1018 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program components through facilities such as Java, JavaScript, ActiveX, and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the Trade Business Card Platform system enabled nodes. The combined application may be nugatory on systems employing standard Web browsers.

### Mail Server

A mail server component 1021 is a stored program component that is executed by a CPU 1003. The mail server may be a conventional Internet mail server such as, but not limited to sendmail, Microsoft Exchange, and/or the. The mail server may allow for the execution of program components through facilities such as ASP, ActiveX, (ANSI) (Objective-) C (++), CGI scripts, Java, JavaScript, PERL, pipes, Python, WebObjects, and/or the like. The mail server may support communications protocols such as, but not limited to: Internet message access protocol (IMAP), Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the Trade Business Card Platform system.

Access to the Trade Business Card Platform system mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 1022 is a stored program component that is executed by a CPU 1003. The mail client may be a conventional mail viewing application such as Apple Mail, Microsoft Entourage, Microsoft Outlook, Microsoft Outlook Express, Mozilla Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 1020 is a stored program component that is executed by a CPU 1003, cryptographic processor 1026, cryptographic processor interface 1027, cryptographic processor device 1028, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the Trade Business Card Platform system may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components, in a component collection, including itself, and/or facilities of the like. The cryptographic component supports encryption schemes allowing for the secure transmission of information across a communications network to enable the Trade Business Card Platform system component to engage in secure transactions if so desired. The cryptographic component facilitates the secure accessing of resources on the Trade Business Card Platform system and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The Trade Business Card Platform Database

The Trade Business Card Platform database component 1019 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the Trade Business Card Platform system database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the Trade Business Card Platform system database is implemented as a data-structure, the use of the Trade Business Card Platform system database 1019 may be integrated into another component such as the Trade Business Card Platform system component 1035. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1019 includes several tables 1019a-i. A users table 1019a includes fields such as, but not limited to: a user name, company name, ip_address, email address, address, profile (e.g., goods/services, import/export, feature set preferences, etc.), user_id, financial_account_id, citizenship, and/or the like. A catalog table 1019b includes fields such as, but not limited to: a goods_id, manufacturer, model_number, serial_number, attributes, facets, features, location, restriction_type, transport_restrictions, taxonomy_id, availability, and/or the like. A country regulations table 1019c includes fields such as, but not limited to: a country_name, country_code, treaties, restrictions, department_of_commerce_contact, intermediary_id, and/or the like. A country restrictions table 1019d includes fields such as, but not limited to: a country_code, approved_goods_id, banned_goods_id, banned_export_countries_id, banned_import_countries_id, approved_export_countries, approved_import_countries, approved_financial_id, banned_financial_id, and/or the like. An financial institution table 1019e includes fields such as, but not limited to: institution_id, approved_countries, approved_goods, banned_countries, banned_goods, and/or the like. A template 1019f includes fields such as, but not limited to: goods_id, financial_institution_id, user_id, user_settings, template_id, source_country_code, intermediary_country_code, destination_country_code, and/or the like. A ads table 1019g includes fields such as, but not limited to: company_id, ad_id, goods_id, and/or the like. A taxonomy table 1019h includes fields such as, but not limited to: goods_id, financial_instution_id, country_regulations_id, country_restrictions_id, template_id, intermediary_id, user_id, and/or the like. A settings table 1019i includes fields such as, but not limited to: settings_id, browser_language, operating_system_language, desired_current_language, application_id, preferences and/or the like. A intermediary table 1019j includes fields such as, but not limited to: intermediary_id, courier_type, courier_id, country, date, and/or the like. A language_translation 1019k includes fields such as, but not limited to: language_id, translation_id, and/or the like. A TBC table 10191 may include fields such as, but not limited to: TBC_ID, company_name, company_address, email_address, password, user_name(s), contact_roster, phone_number, fax_number, affiliate_number, authorized_buyer_info, signatory_info, d&b#, FED#, EIN#, state_resale_certification, logo, trademark, authorizations, access_levels, ranks, scores, and/or the like.

In one embodiment, the Trade Business Card Platform system database may interact with other database systems. For example, employing a distributed database system, queries and data access by Trade Business Card Platform system component may treat the combination of the Trade Business Card Platform system database, an integrated data security layer database as a single database entity.

In one embodiment, user programs may contain various user interface primitives, which may serve to update the Trade Business Card Platform system. Also, various accounts may require custom database tables depending upon the environments and the types of clients the Trade Business Card Platform system may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1019a-e. The Trade Business Card Platform system may be configured to keep track of various settings, inputs, and parameters via database controllers.

The Trade Business Card Platform system database may communicate to and/or with other components in a component collection, including itself, and/or facilities of the like. Most frequently, the Trade Business Card Platform system database communicates with the Trade Business Card Platform system component, other program components, and/or the like. The database may contain, retain, and provide information regarding other nodes and data.

### The Trade Business Card Platform System

The Trade Business Card Platform system component 1035 is a stored program component that is executed by a CPU. The Trade Business Card Platform system affects accessing, obtaining and the provision of information, services, transactions, business information, and/or the like across various communications networks.

Through its various components, the cross-border Trade Business Card Platform creates new markets by generating and facilitating three stages of a cross-border trade transaction: identification, selection and execution. The Trade Business Card Platform has many numerous and revolutionary components to facilitate cross-border transactions, such as, but not limited to: a classification taxonomy, multi-lingual facilities, a search-enhancing thesaurus, an acquisition matrix core, a logistical fulfillment matrix, payment matrix, an elegant User Interface (UI), and/or the like.

The Trade Business Card Platform system component enabling access of information between nodes may be developed by employing standard development tools such as, but not limited to: (ANSI) (Objective-) C (++), Apache components, binary executables, database adapters, Java, JavaScript, mapping tools, procedural and object oriented development tools, PERL, Python, shell scripts, SQL commands, web application server extensions, WebObjects, and/or the like. In one embodiment, the Trade Business Card Platform system server employs a cryptographic server to encrypt and decrypt communications. The Trade Business Card Platform system component may communicate to and/or with other components in a component collection, including itself, and/or facilities of the like. Most frequently, the Trade Business Card Platform system component communicates with the Trade Business Card Platform system database, operating systems, other program components, and/or the like. The Trade Business Card Platform system may contain, communicate, generate, obtain, and/or provide program component, system, user, and/or data communications, requests, and/or responses.

### Distributed Trade Business Card Platform

The structure and/or operation of any of the Trade Business Card Platform node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the Trade Business Card Platform controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. Again, the configuration will depend upon the context of system deployment.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

What is claimed is:

1. A processor-implemented method to generate a persistent transactional account profile data record, comprising:
receiving business profile data inputs associated with a business, including at least one business identifier configured to grant access to business information associated with the business from a business information repository;
submitting the at least one business identifier to the business information repository;
receiving business information associated with the business from the business information repository in response to the submission of the at least one business identifier;
populating a business profile data record with a subset of the business profile data and the business information; and
persisting the business profile data record in a business profile record database.

2. The method of claim 1, further comprising:
granting a higher access level to the business within an online transactional environment after the business profile data record has been persisted.

3. The method of claim 1, wherein the business information repository comprises a credit rating agency.

4. The method of claim 1, wherein the business information repository comprises a repository of business reliability information.

5. The method of claim 1, wherein the business profile data includes an electronic address, and further comprising:
sending an electronic message to the electronic address, the electronic message including an embedded link; and
receiving a notification of selection of the embedded link before persisting the business profile data.

6. The method of claim 1, further comprising:
receiving a transaction interest indicator for a transaction from the business;
querying the business profile data record associated with the business from the business profile record database; and
automatically populating a web form associated with the transaction based on information extracted from the business profile data record.

7. The method of claim 1, further comprising:
analyzing business profile data inputs to establish compliance with a set of criteria; and
prompting for re-entry of non-compliant business profile data inputs.

8. The method of claim 7, wherein the set of criteria include completeness of essential business profile data inputs.

9. The method of claim 7, wherein the set of criteria include proper formatting of a subset of business profile data inputs.

10. The method of claim 1, wherein the business profile data inputs further include at least one listing of authorized individuals to receive communications directed to the business through information contained in the business profile data record.

11. The method of claim 1, further comprising:
analyzing the business information in accordance with a set of access criteria;
determining a status assignment for the business based on the analysis of the business information; and
incorporating the status assignment into the business profile data record.

12. The method of claim 11, wherein the status assignment comprises a restricted access level within an online transactional environment.

13. The method of claim 11, wherein the status assignment comprises a credit rating.

14. The method of claim 13, further comprising:
receiving a transaction interest indicator for a transaction from the business;
querying a payment requirement associated with the transaction;
comparing the payment requirement with the credit rating;
forming a compliance message based on the comparison between the payment requirement and the credit rating; and
providing the compliance message to a counterparty to the transaction.

15. The method of claim 11, wherein the status assignment comprises a commercial reliability rating.

16. The method of claim 1, further comprising:
providing the business profile data record to a transactional counterparty within an online transactional environment.

17. The method of claim 16, wherein the providing the business profile data record comprises:
packaging information contained in the business profile data record as an electronic business card; and
imparting the electronic business card to the transactional counterparty.

18. The method of claim 16, wherein the providing the business profile data record comprises:
populating a contact record in an address book belonging to the transactional counterparty based on information contained in the business profile data record.

19. The method of claim 1, wherein the business profile data further comprises a business name and business contact information.

20. The method of claim 1, wherein the business profile data further comprises authorized buyer information.

21. The method of claim 1, wherein the business profile data further comprises signatory information.

22. A processor-implemented system to generate a persistent transactional account profile data record, comprising:
means to receive business profile data inputs associated with a business, including at least one business identifier configured to grant access to business information associated with the business from a business information repository;
means to submit the at least one business identifier to the business information repository;
means to receive business information associated with the business from the business information repository in response to the submission of the at least one business identifier;
means to populate a business profile data record with a subset of the business profile data and the business information; and
means to persist the business profile data record in a business profile record database.

23. An apparatus to generate a persistent transactional account profile data record, comprising:
a memory;
a processor disposed in communication with said memory, and configured to issue a plurality of processing instructions stored in the memory, wherein the instructions comprise:
receive business profile data inputs associated with a business, including at least one business identifier configured to grant access to business information associated with the business from a business information repository;
submit the at least one business identifier to the business information repository;
receive business information associated with the business from the business information repository in response to the submission of the at least one business identifier;
populate a business profile data record with a subset of the business profile data and the business information; and
persist the business profile data record in a business profile record database.

24. A processor-accessible medium to generate a persistent transactional account profile data record, comprising:
processor readable instructions stored in the processor-accessible medium, wherein the processor readable instructions are issuable by a processor to:
receive business profile data inputs associated with a business, including at least one business identifier configured to grant access to business information associated with the business from a business information repository;
submit the at least one business identifier to the business information repository;
receive business information associated with the business from the business information repository in response to the submission of the at least one business identifier;
populate a business profile data record with a subset of the business profile data and the business information; and
persist the business profile data record in a business profile record database.
